(19) United States
(12) Patent Application Publication
(10) Pub. No.: US 2016/0171572 A1
(43) Pub. Date: Jun. 16, 2016

(54) METHODS AND SYSTEMS THAT AGGREGATE MULTI-MEDIA REVIEWS OF PRODUCTS AND SERVICES

(71) Applicant: ABBYY Development LLC, Moscow (RU)

(72) Inventor: Ding Yuan Tang, Pleasanton, CA (US)

(21) Appl. No.: 14/572,064

(22) Filed: Dec. 16, 2014

(51) Int. Cl. G06Q 30/06; G06F 3/0484; G06F 3/0482; G06F 17/30

(52) U.S. Cl. CPC G06Q 30/0609; G06F 17/30424; G06F 17/30554; G06F 3/0484; G06F 3/0482

(57) ABSTRACT

The current document is directed to methods and systems that facilitate authoring of multi-media reviews of products and services and that aggregate multi-media reviews of products and services submitted by multiple reviewers using distributed-computing technologies. In one disclosed implementation, a client-side application provides to reviewers authoring tools, lists of desired review topics, and analyses of submitted multi-media reviews. The client-side application communicates with one or more aggregation servers. The one or more aggregation servers distribute information about desired review topics, receive multi-media reviews submitted by reviewers using the client-side application, return analysis of submitted reviews to reviewers, and store multi-media reviews submitted by reviewers for subsequent access by, and dissemination to, retailers and other parties.

### TECHNICAL FIELD

The current document is related to distributed computing and multi-media presentations and, in particular, to methods and systems for creating and aggregating multi-media reviews of products and services.

### BACKGROUND

Reviews of products and services have long been used to promote retail sales. With the emergence of Internet-based e-commerce during the past 20 years, customer reviews and ratings have gained increased prominence and importance for facilitating retailing of products and services. Many consumers have grown to depend on review of products and services as an important component of the information that they assemble and consider as they make purchasing decisions. However, despite the many advanced capabilities for information transfer and display provided by modern distributed computer systems, reviews of products and services are, for the most past, text-based, often consisting of a few sentences or short paragraphs accompanied by a simple textural or graphical rating, such as a star-based rating. Moreover, in many cases, no reviews or only a few reviews are available for particular products and services. In addition, reviews often vary considerably in information content, readability, and objectiveness. As both traditional store-front retailers and Internet retailers continue to seek new advantages in their increasingly competitive retailing marketplaces, advances in customer-review solicitation and procurement and would be welcomed by both traditional store-front retailers and Internet retailers, their customers, of reviewers.

### SUMMARY

The current document is directed to methods and systems that facilitate authoring of multi-media reviews of products and services and that aggregate multi-media reviews of products and services submitted by multiple reviewers using distributed-computing technologies. In one disclosed implementation, a client-side application provides to reviewers authoring tools, lists of desired review topics, and analyses of submitted multi-media reviews. The client-side application communicates with one or more aggregation servers. The one or more aggregation servers distribute information about desired review topics, receive multi-media reviews submitted by reviewers using the client-side application, return analysis of submitted reviews to reviewers, and store multi-media reviews submitted by reviewers for subsequent access by, and dissemination to, retailers and other parties.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIG. 5A illustrates two types of virtual machine and virtual-machine execution environments.

FIG. 5B illustrates two types of virtual machine and virtual-machine execution environment.

FIG. 6 illustrates an example environment in which a distributed review-aggregation system operates.

FIG. 7 illustrates, in block-diagram fashion, the basic aggregation operation performed by the distributed review-aggregation system.

FIG. 8A illustrates an example user interface provided by a client-side review-authoring and review-submission application.

FIG. 8B illustrates an example user interface provided by a client-side review-authoring and review-submission application.

FIG. 8C illustrates an example user interface provided by a client-side review-authoring and review-submission application.

FIG. 8D illustrates an example user interface provided by a client-side review-authoring and review-submission application.

FIG. 8E illustrates an example user interface provided by a client-side review-authoring and review-submission application.

FIG. 8F illustrates an example user interface provided by a client-side review-authoring and review-submission application.

FIG. 8G illustrates an example user interface provided by a client-side review-authoring and review-submission application.

FIG. 9A provides general descriptions of the implementation of the client-side-application and aggregation-server components of the distributed review-aggregation system.

FIG. 9B provides general descriptions of the implementation of the client-side-application and aggregation-server components of the distributed review-aggregation system.

FIG. 10A provides a small portion of an example state-transition diagram for a client-side application component of a distributed review-aggregation system.

FIG. 10B provides a small portion of an example state-transition diagram for a client-side application component of a distributed review-aggregation system.

FIG. 11A illustrates a portion of the relational database tables that may be constructed and used by certain implementations of the aggregation server.

FIG. 11B illustrates a portion of the relational database tables that may be constructed and used by certain implementations of the aggregation server.

FIG. 11C illustrates a representation of a multi-media-review-package data structure transferred from the client-side application to the aggregation server when a review is submitted by a reviewer to the distributed review-aggregation system.

FIG. 12 illustrates using control-flow diagrams, aggregation-server handling of various types of requests.

FIG. 13 illustrates using control-flow diagrams, aggregation-server handling of various types of requests.

FIG. 14 illustrates using control-flow diagrams, aggregation-server handling of various types of requests.

FIG. 15A illustrates using control-flow diagrams, aggregation-server handling of various types of requests.

FIG. 15B illustrates using control-flow diagrams, aggregation-server handling of various types of requests.

FIG. 15C illustrates using control-flow diagrams, aggregation-server handling of various types of requests.

FIG. 15D illustrates using control-flow diagrams, aggregation-server handling of various types of requests.

FIG. 15E illustrates using control-flow diagrams, aggregation-server handling of various types of requests.

FIG. 15F illustrates using control-flow diagrams, aggregation-server handling of various types of requests.

FIG. 16 illustrates using control-flow diagrams, aggregation-server handling of various types of requests.

FIG. 17 illustrates the general operational environment of the review-distribution system.

FIG. 18 illustrates a portion of an example web-page-based user interface provided by the review-distribution system to clients of the review-distribution system.

FIG. 19 illustrates a portion of an example web-page-based user interface provided by the review-distribution system to clients of the review-distribution system.

FIG. 20 illustrates a portion of an example web-page-based user interface provided by the review-distribution system to clients of the review-distribution system.

FIG. 21 illustrates a portion of an example web-page-based user interface provided by the review-distribution system to clients of the review-distribution system.

FIG. 22 illustrates a portion of an example web-page-based user interface provided by the review-distribution system to clients of the review-distribution system.

FIG. 23 is a control-flow diagram for a general implementation of the review-distribution system.

FIG. 24 provides a portion of a state-transition diagram, similar to the state-transition diagrams shown in FIGS. 10A-B, for interaction between clients of the review-distribution system and the review-distribution system.

FIG. 25 illustrates additional relational database tables employed by the review-distribution system, along with tables identical or similar to the relational-database tables discussed above with reference to FIGS. 11A-B, to store information related to sales of multi-media reviews and auctions of multi-media reviews.

### DETAILED DESCRIPTION

The current document is directed to methods and systems that facilitate authoring of reviews of products and services and that aggregate of multi-media reviews to allow the multi-media reviews to be accessed and used by retailers of the products and services. In a first subsection, overview of computers and distributed computing is provided. In a second subsection, a detailed description of a distributed review-aggregation system is provided. In a third subsection, a review-distribution system, to which the current application is directed, is described in detail.

### Computer Hardware, Distributed Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

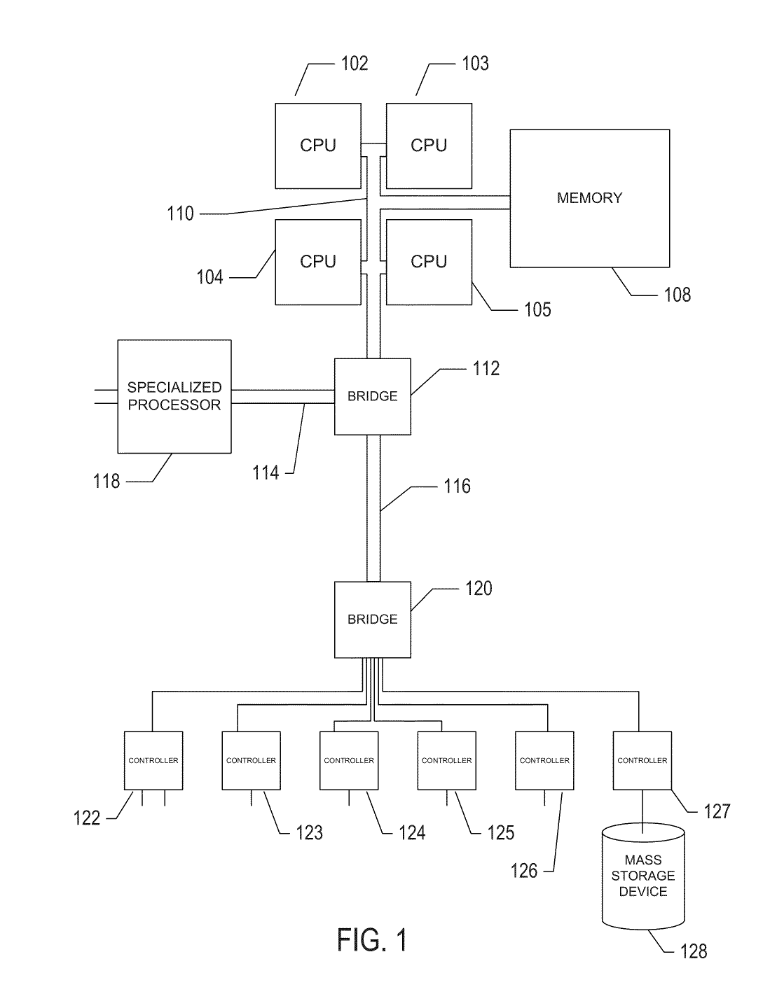

FIG. 1 provides a general architectural diagram for various types of computers. Computers that receive, process, and store multi-media reviews of products and services may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

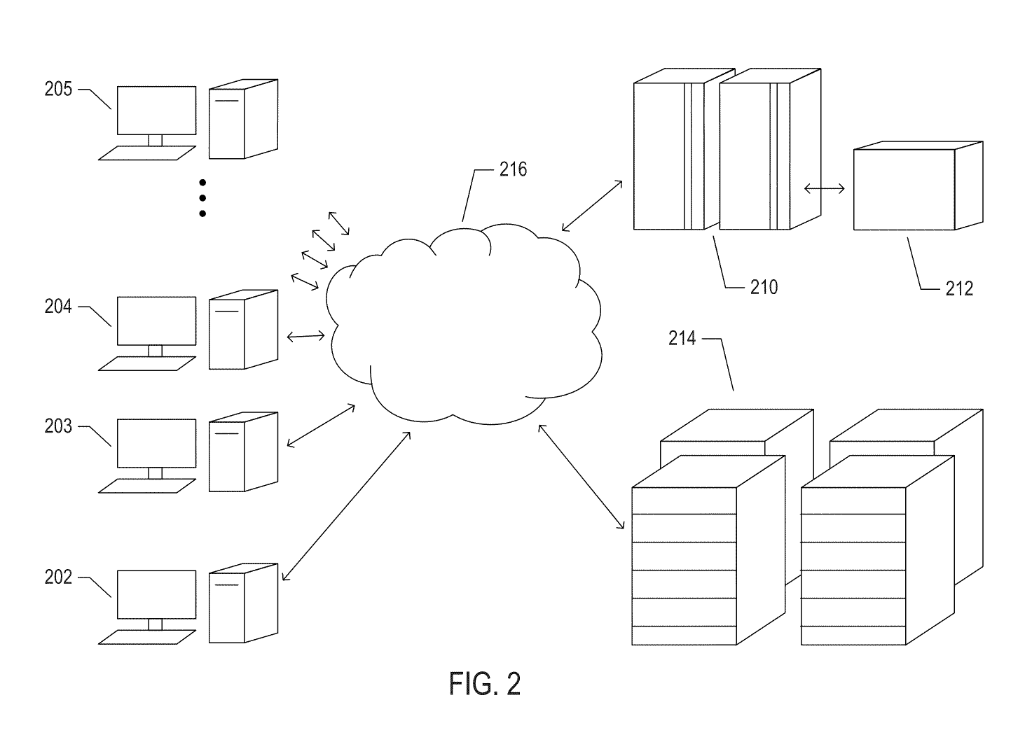

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

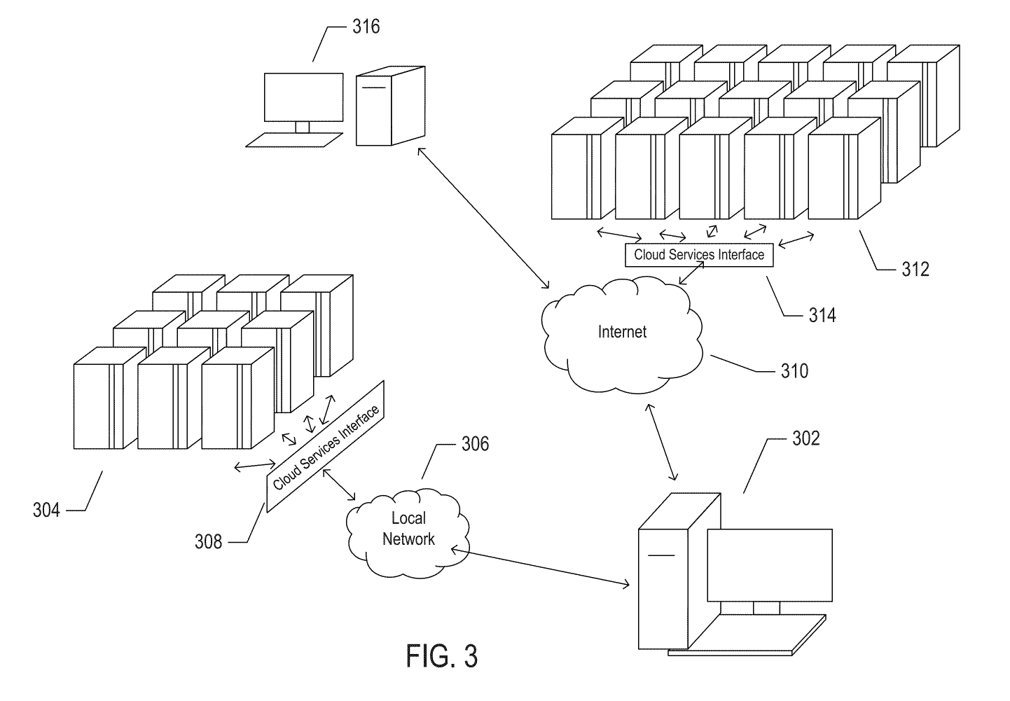

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

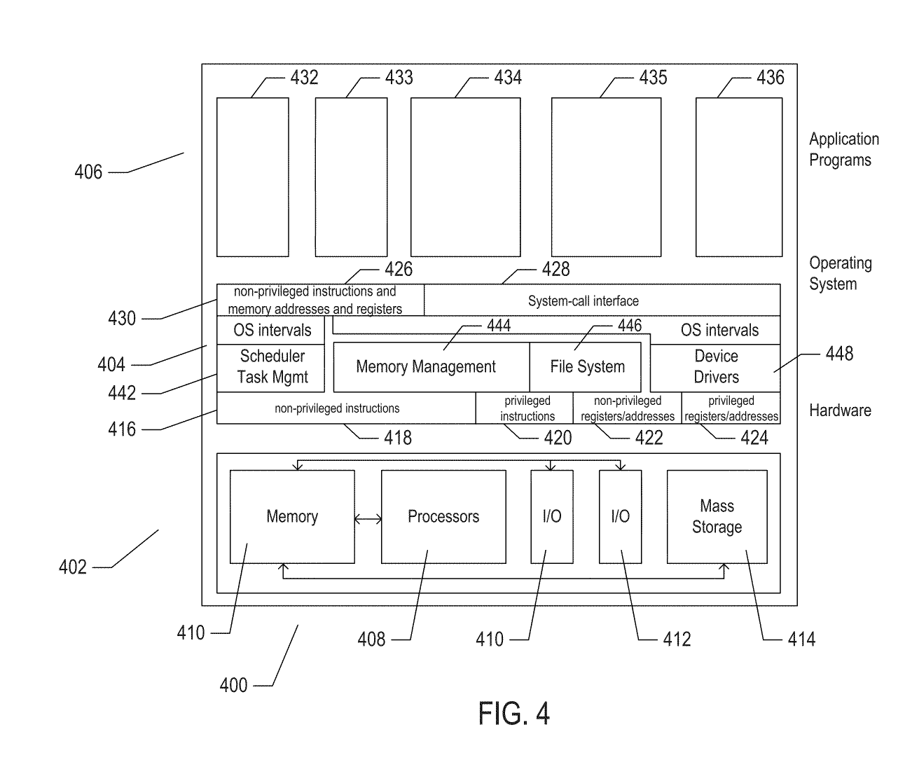

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

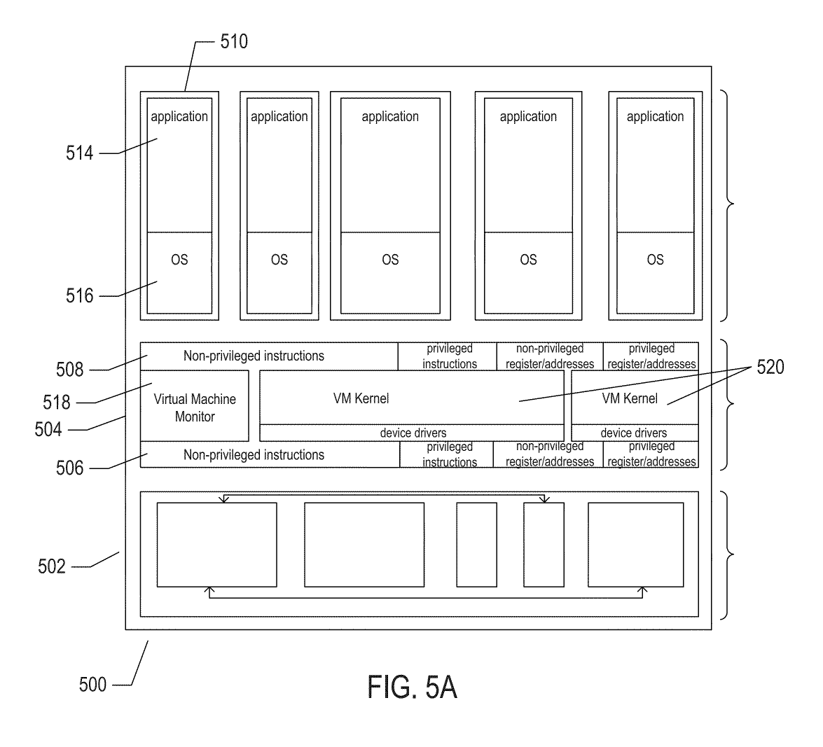

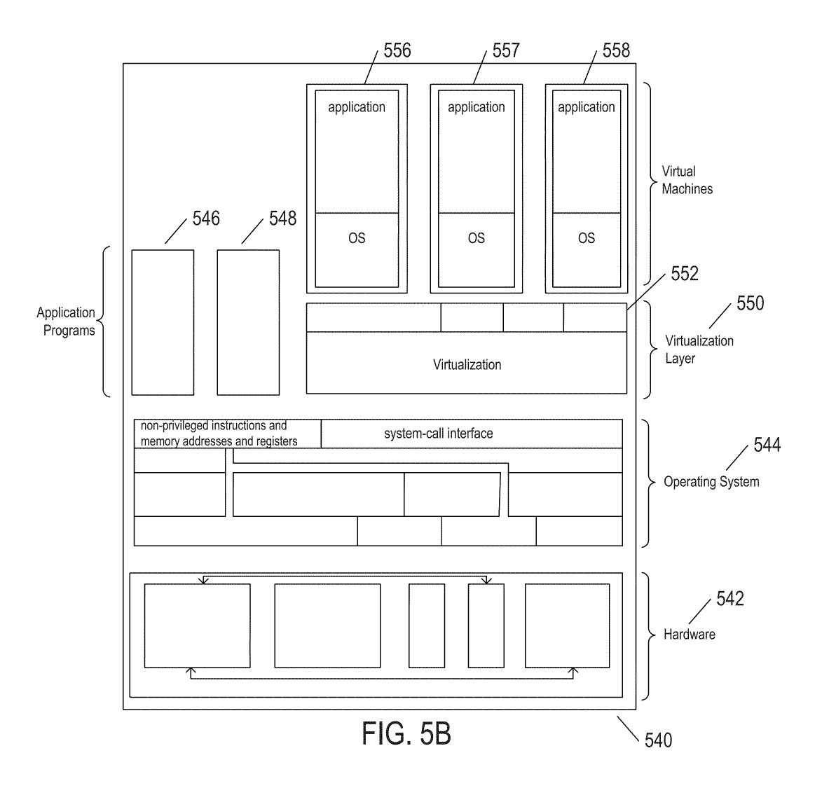

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

Many implementations of the distributed review-aggregation system, discussed in the following subsection, employ large numbers of virtual servers within virtual data centers provided by cloud-computing facilities. Other implementations may employ standalone aggregation servers and various types of private data centers. In all implementations, the distributed review-aggregation system consists of complex hardware platforms, various electronic user devices, and control components stored and executed within these hardware platforms and electronic user devices that, in part, comprise millions of electronically stored processor instructions.

### Distributed Review-Aggregation System

Currently, reviews of products and services provided by consumers and purchasers to Internet retailers are generally short, text-based reviews accompanied by a graphical or textural rating, such as a number of stars representing a ratio of assigned stars to the maximum possible number of assignable stars. These reviews are often furnished to Internet retailers through simple web-page-based interfaces that allow a consumer to type a review into a text-entry window, using a keyboard, and to assign a rating by clicking some number of stars within a row containing the maximum number of stars that can be assigned to a particular product or service. Text-based reviews are easy to write, easy to collect via simple web-page interfaces, and generally easy for potential customers to read and understand. However, these text-based reviews do not take advantage of the many multi-media capabilities of modern distributed computer systems and modern user devices, including mobile phones, laptops, tablets, and personal computers. Furthermore, reviews are generally provided through retailer-specific web-page interfaces, which potential reviewers need to find and learn to use. In the fast-paced world of Internet retailing, users may have little incentive to spend the time to figure out how to submit reviews to retailers. As a result, the quantity of well-written, useful reviews available for display to potential consumers and purchasers by Internet retailers may fail to meet the needs of the retailers and their potential consumers and purchasers. Furthermore, many retailers may lack the expertise and resources to solicit and collect reviews, particularly for products and services sold predominantly in storefronts and other retail locations. Potential consumers and purchasers may also wonder whether reviews displayed by retailers have been edited to appear more favorable than intended by the reviewers or represent only a small, favorable portion of a much larger body of less sanguine reviews, and the reviews that are displayed often vary widely in useful-information content.

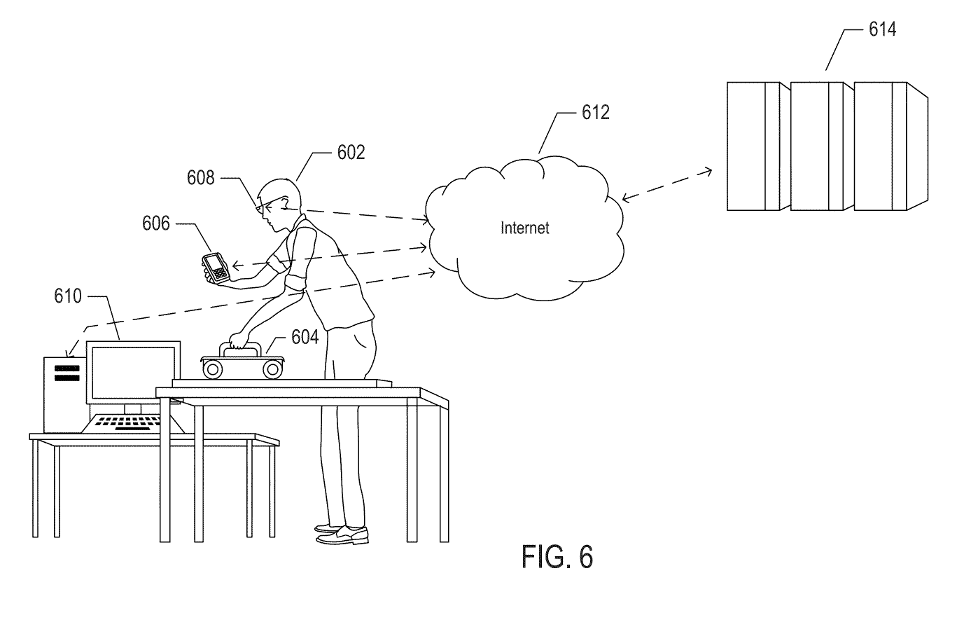

The current document is directed to methods and systems that facilitate authoring of multi-media reviews of products and services by consumers, purchasers, and/or users of the products and services and that collect and store the reviews by aggregation servers for subsequent access by, and display to, retailers seeking to acquire reviews and/or potential customers and purchasers seeking product and service information. FIG. 6 illustrates an example environment in which a distributed review-aggregation system operates. In FIG. 6, a purchaser and user 602 of a hand-held product 604 is producing a multi-media review of the product using a mobile phone 606, a wearable computing device embedded within a pair of glasses 608, and a personal computer 610. The mobile phone 606, wearable computing device 608, and personal computer 610 can intercommunicate via the Internet 612. A client-side review-authoring application, referred to below as the “client-side application” or “client application,” runs on one or more of the user's devices to collect different types of information from the user's devices and packages this information into a multi-media review. The client-side application submits the completed review through the Internet to an aggregation server running within a cloud-computing facility 614 or other private or public data center as part of a distributed review-aggregation system. Reviews collected from users are subsequently made available by the distributed review-aggregation system, which includes aggregation servers and other facilities within one or more cloud-computing facilities or other private or public data centers, to retailers seeking consumer reviews for inclusion in web sites, kiosk displays, or other review-presentation facilities and, in certain cases, to potential consumers and purchasers and other interested parties. The reviewer 602 may collect still photos, videos, and audio presentations through one or more of the various devices employed by the reviewer and may also provide textural information through keyboard entry to the mobile phone 606 or personal computer 610. As personal electronic devices continue to develop, reviewers may soon routinely collect three-dimensional images, generate automated animations, and collect many additional types of media objects for inclusion in multi-media reviews. The distributed review-aggregation system, in certain implementations, provides monetary or credit-based remuneration to reviewers in order to incentivize reviewers to furnish multi-media reviews on desired topics. In certain implementations, the distributed review-aggregation system sells and/or rents multi-media reviews to retailers and to others interested in accessing the collected multi-media reviews. As part of the purchase and/or rental agreements, the distributed review-aggregation system may limit the ability of reviewers to edit or extract only portions of purchased or rented reviews and may require retailers to display trademarks or other indications that the reviews were obtained from the retail aggregator in order to increase public confidence in the authenticity and completeness of reviews displayed by retailers to potential consumers and purchasers. Reviewers may maintain local copies of submitted multi-media reviews or store copies in storage facilities made available by social networking sites and/or cloud-computing facilities to facilitate monitoring of the authenticity and completeness of reviews purchased from the distributed review-aggregation system and displayed by retailers and other parties. The distributed review-aggregation system may provide any of many different types of purchase and licensing options to reviewers to allow reviewers to maintain partial rights to reviews submitted by the reviewers to the distributed review-aggregation system.

Multi-media consumer reviews provide many advantages to consumers of the reviews. It is often far more interesting and informative to watch a video of a product being used or a service being performed than to read a short textural description of a product or service. Reviewers often communicate emotions and reactions more effectively using still photographs, video clips, and audio tracks than they are able to communicate by writing alone. The many different types of media that can be incorporated within a multi-media review allow reviewers greater creativity and flexibility in crafting reviews and, when incentivized by remuneration from the distributed review-aggregation system, this potential for creativity may result in a far more interesting and engaging selection of useful information than could be produced by even the most sophisticated of marketing organizations.

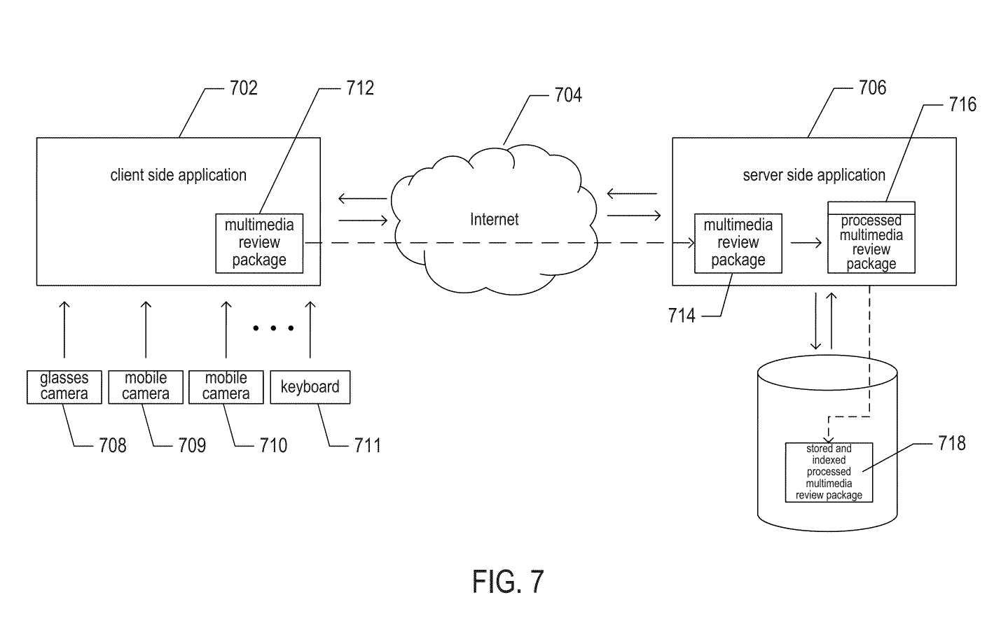

FIG. 7 illustrates, in block-diagram fashion, the basic aggregation operation performed by the distributed review-aggregation system. As shown in FIG. 7, a client-side application 702 runs in one or multiple user devices and communicates, via the Internet 704, with a server-side application running on one or more aggregation servers 706 within a cloud-computing facility or other private or public data center. The client-side application collects various different types of information output from various of the user's personal devices 708-711 and assembles the information, according to control inputs provided by the reviewer, into a multi-media review package 712 that the client-side application electronically transfers to the server-side application 714. The server-side application processes the received multi-media review package into a processed multi-media review package 716 and stores the processed multi-media review package in one or more data-storage facilities 718. In general, the processed multi-media review packages may be stored and indexed within any of various different types of database systems in order to facilitate rapid and intelligent retrieval for subsequent provision to retailers and other interested parties.

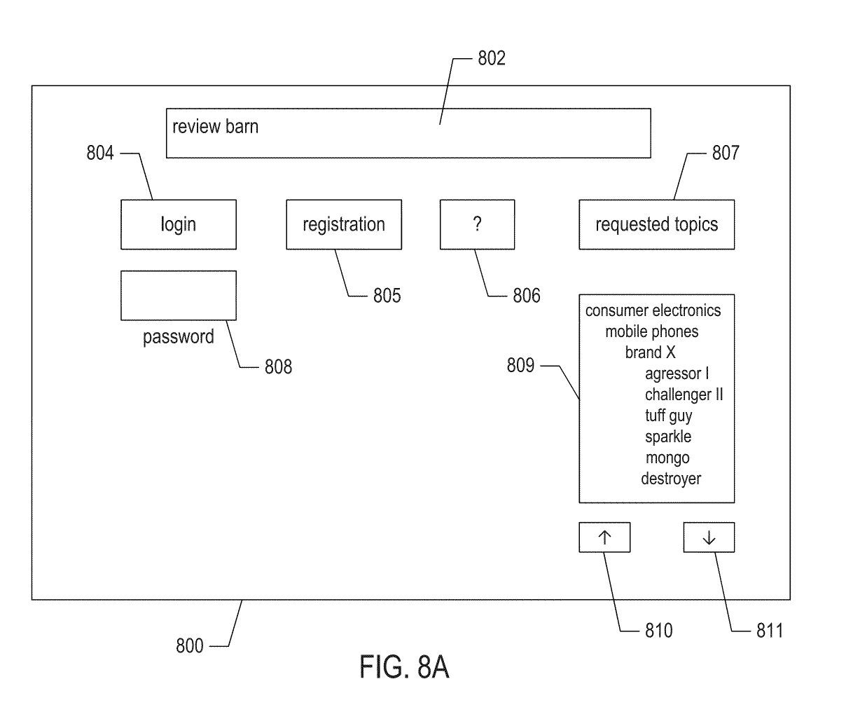

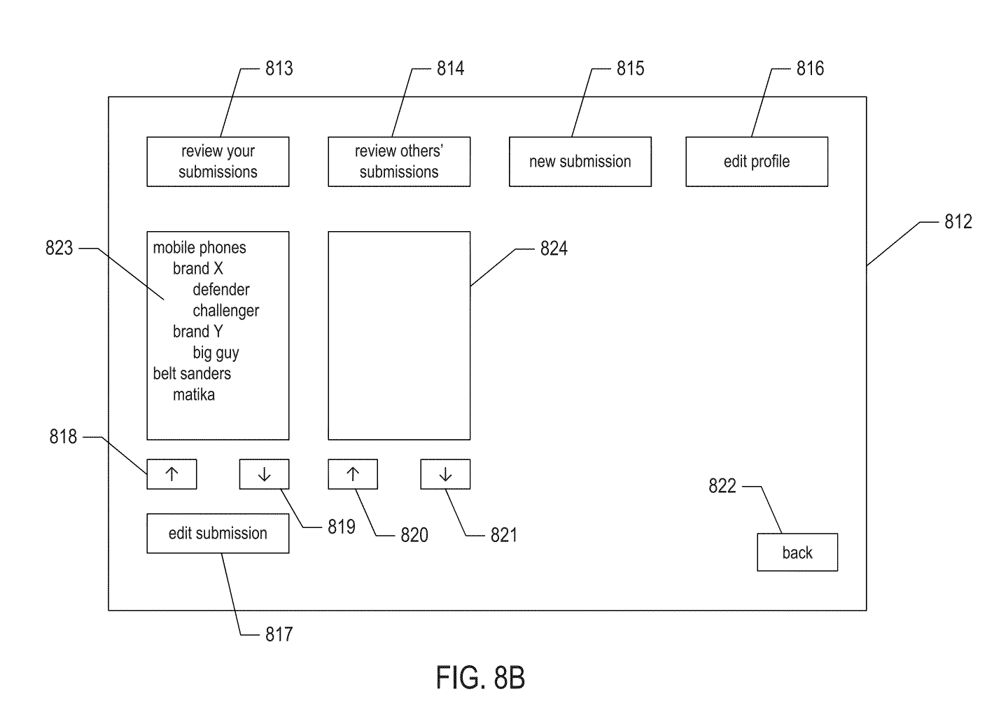

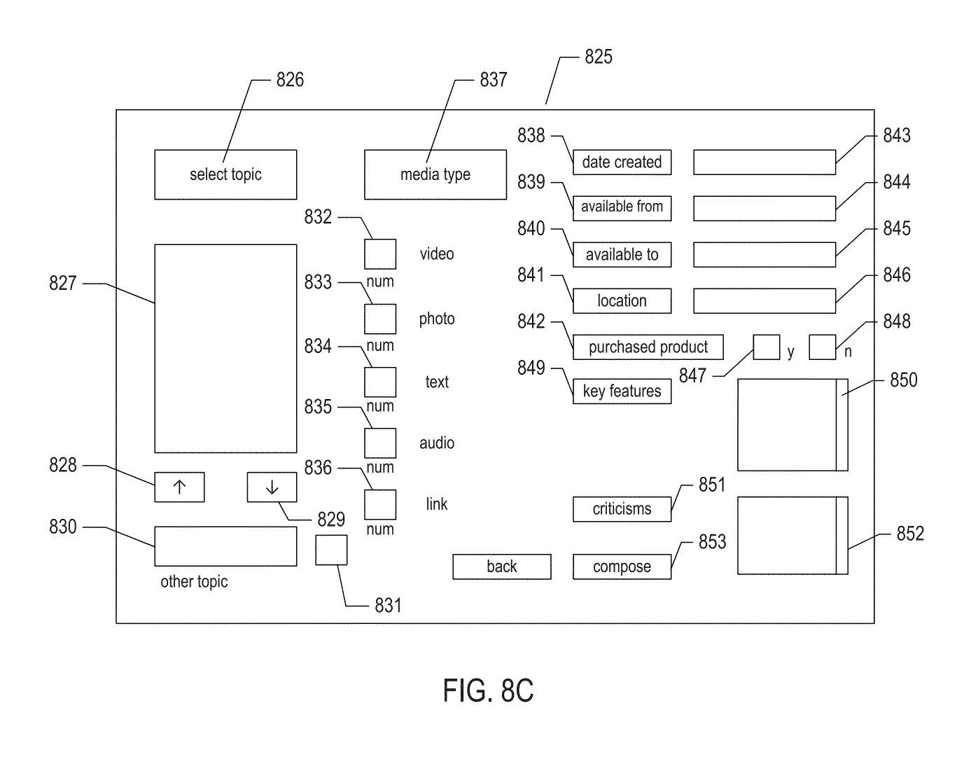

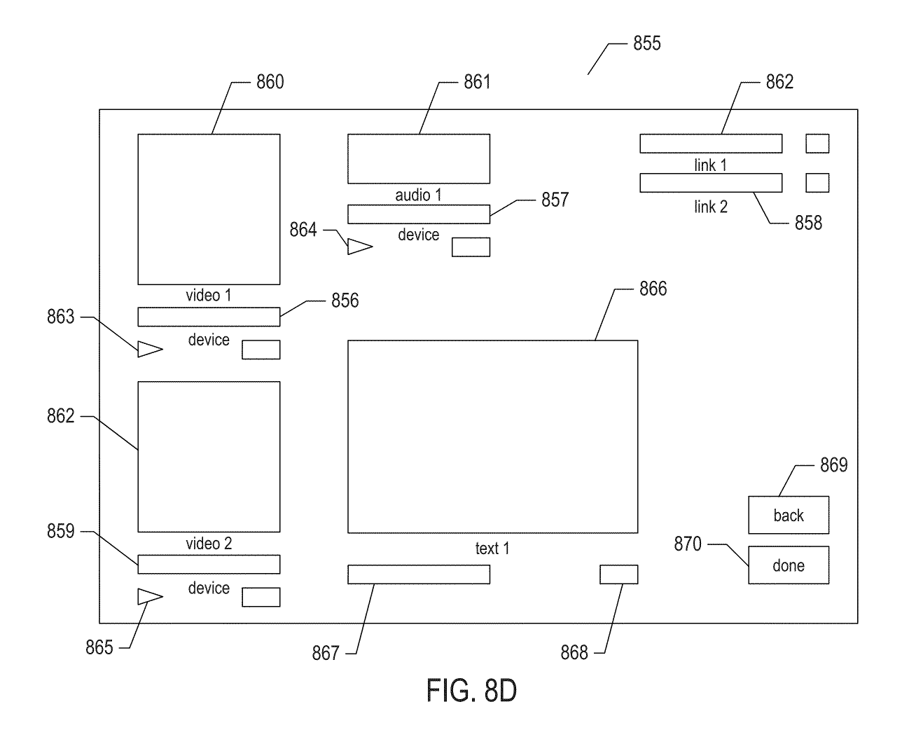

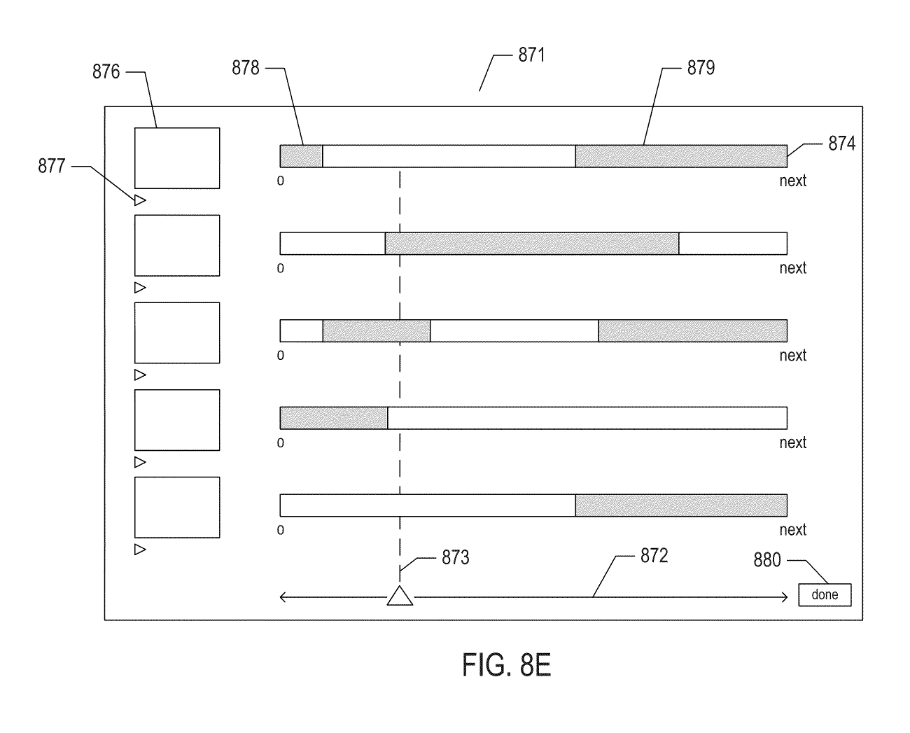

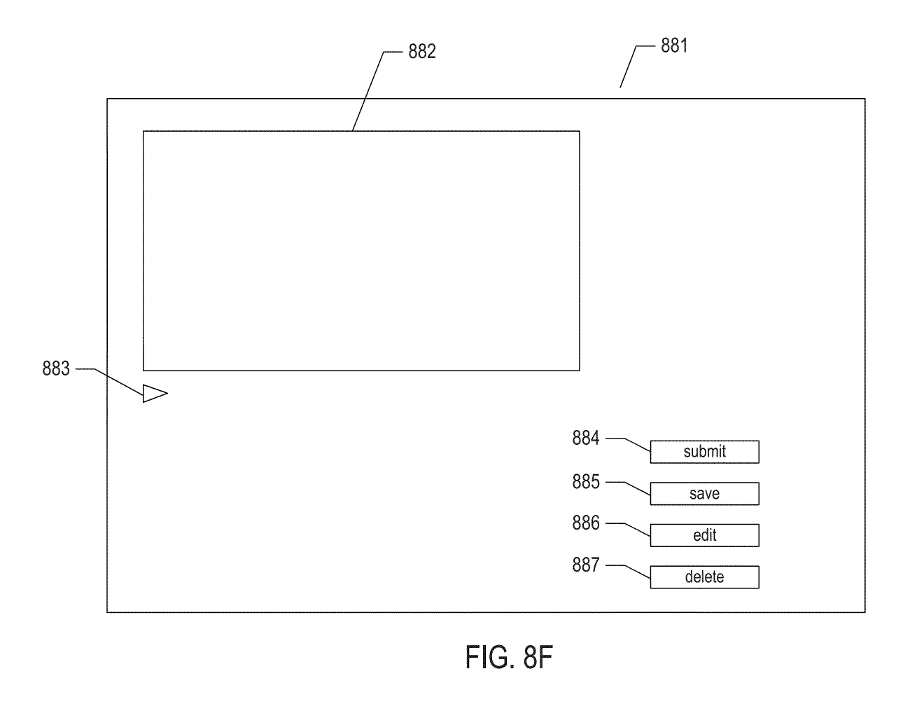

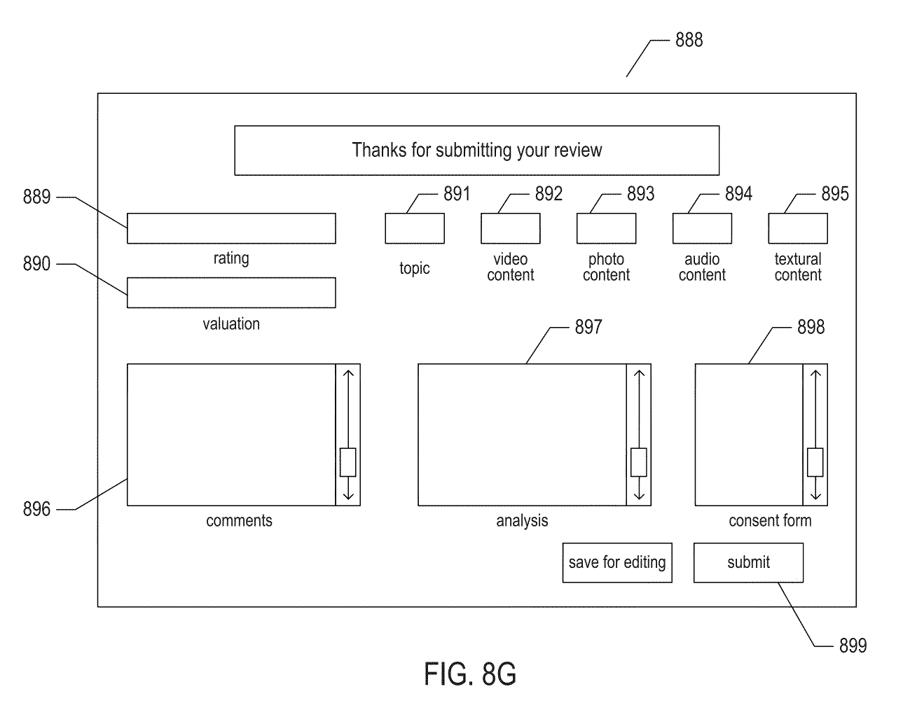

FIGS. 8A-G illustrate an example user interface provided by a client-side review-authoring and review-submission application. It should be emphasized that this example user interface is but one of many different possible user interfaces that may be provided by client-side applications. Alternative user interfaces may include a greater number or smaller number of features, different features, different numbers of display pages, and may use different types of display and input-entry features. The user interface shown in FIGS. 8A-F can be displayed by personal computers, laptops, and cell phones, while other types of user interfaces may be more appropriate for other types of electronic devices. Only a subset of the pages of the example user interface are shown in FIGS. 8A-G in order to provide a concise but general illustration of the client-side-application functionality provided to reviewers.

FIG. 8A shows an initial page displayed by the client-side application following launching of the client-side application. The initial page includes display of the name of the distributed review-aggregation system 802 with which the client-side application is communicating and additionally includes four input features 804-807. User input to the input features requests various operations supported by the distributed review-aggregation system that includes the client-side application, one or more aggregation servers, and other distributed computing facilities to support the one or more aggregation servers. When a user types a password into the password-entry feature 808 and clicks on the login feature 804, the client-side application interacts with an aggregation server to log the user into the distributed review-aggregation system. User input to the registration feature 805 allows a new user to register with the distributed review-aggregation system. User input to the help feature 806 launches a series of help displays, search features, and dialogs to allow a user to obtain information about the distributed review-aggregation system. User input to the requested-topics feature 807 fetches the current requested topics or a subset of the current requested topics from an aggregation server for display in a requested-topics-display window 809. A user may scroll up or down through the displayed topics in the requested-topics-display window 809 using scrolling features 810 and 811. The review-aggregator-name-display feature 802 may be static or, in certain implementations, may display multiple distributed review-aggregation systems, allowing a user to choose which of the multiple distributed review-aggregation systems with which to interact via client-side application. In these implementations, the client-side application supports interaction with multiple different review aggregators. In other implementations, the client-side application is a dedicated, proprietary application for a particular review aggregator. The requested-topics feature 807 and requested-topics-display window 809 furnish useful information to potential reviewers. The displayed requested topics represent those topics for which there is the greatest demand from retailers and other parties accessing the distributed review-aggregation system. In general, when reviewers are paid or reimbursed for submitting reviews, reviews related to these most desired topics generally result in the greatest payment or compensation and have the greatest chances of widespread distribution with subsequent downstream revenues. The registration feature 805 instructs the client-side application to collect information needed for a user profile that is submitted to, and stored within, the distributed review-aggregation system. Storage of reviewer profiles increases the efficiency of request/response exchanges between reviewers and the distributed review-aggregation system. The client-side application also provides reviewer-profile-editing facilities, in cooperation with an aggregation server, to allow reviewers to update their reviewer profiles.

FIG. 8B shows a high-level menu page displayed to a user who successfully logs into the distributed review-aggregation system via input of a valid password and input to the login feature 804 included in the initial page shown in FIG. 8A. The high-level menu page 812 includes command-input features 813-817, display-scrolling features 818-821, and navigation feature 822. User input to feature 813 results in display, in display window 823, of the names and/or identifiers (“IDs”) of reviews previously submitted by the reviewer to the distributed review-aggregation system. The reviewer may select one of these submissions by user input and launch an editing session by input to the edit-submission input feature 817. The similar input feature 814 and display window 824 allows a reviewer to review other reviewers' submissions. User input to new-submission input feature 815 begins a process for authoring and submitting a new review. User input to the edit-profile feature 816 allows a user to edit the contents of the user's reviewer profile. The ability of users, in the described implementation, to review other reviewer's submissions may assist a user in understanding how to create a useful and viable review and may allow a user to acquire new ideas and techniques for authoring reviews.

FIG. 8C illustrates a first page of a new-review-authoring dialog invoked by user input to the new-submission input feature 815 shown in FIG. 8B. The first page 825 of the review-authoring dialog includes a variety of input features to input metadata for a new product or service review. Only a few of the different types of input features that may be provided by the client-side application are shown on the example first review-authoring-dialog page 825 shown in FIG. 8C. A select-topic input feature 826, topic display window 827, display-window-scrolling features 828-829, other-topic-entry window 830, and other-topic-select input feature 831 allow a user to select one of a number of standard review topics provided by the distributed review-aggregation system to associate with the new review or to input a new topic for the review. Input features 832-836 allow a user to input the number of media objects of each of various different media types and to then input a mouse click or other user input to the media-type input feature 837 to store the numbers of the various different types of media objects to be included in the review. Input features and associated text-entry windows 838-842 and 843-848 allow a user to input various types of metadata for the new review, including the date created, the date that the user wishes the review to be available from, the date the user wishes the review to be available to, a location at which the review was created, and an indication of whether or not the user purchased the product or service with respect to which the review is created. A key-features input feature 849 and associated text-input window 850 allows a user to enter textural descriptions of various key features of the product or service and a criticisms input feature 851 and associated text-input window 852 allow a user to input various criticisms and disadvantages of the product or service being reviewed. Navigation feature 853 results in display of a next review-authoring page, described below with reference to FIG. 8D.

FIG. 8D shows a review-composition page accessed by a user via input to the compose input feature 853 shown in FIG. 8C. The review-composition page 855 includes text-input windows that allow a user to input specifications of a device and other media-object indications that allow the device on which the client-side application runs to download or receive streaming input of a media object from the device. Once a media object has been downloaded or streamed to the client-side application, the media objects can be played for review to the user using presentation features 860-862 with associated control features 863-865, for visual and audio media types. Textural components of reviews can be input to a text-entry window 866 via a keyboard associated with the device running the client-side application or may be downloaded using a file-specification-entry window 867 and fetch input feature 868. Presentation windows and specification-input windows are provided for each of the media objects entered through the media-type input feature 837 shown in FIG. 8C. Navigation features 869 and 870 allow a user to return to the previous page shown in FIG. 8C or advance to the timeline page shown in FIG. 8E and discussed below.

FIG. 8E illustrates a timeline page that allows users to specify time intervals at which media objects play with respect to an overall timeline for a multi-media review. The timeline page 871 includes an indication of the overall timeline 872 and a movable vertical bar 873 that can be moved by the user to any point along the timeline. The vertical bar is used to indicate a starting point or ending point for a particular interval. An individual timeline is provided for each media object in association with a small presentation window in which the media object can be played. For example, media-object timeline 874 is associated with presentation window 876 and input feature 877 and all of these features of the timeline page 871 are associated with video media object input via features 856 and displayed in display window 860 of the review-composition page 855 shown in FIG. 8D. In FIG. 8E, shading is used to indicate rendering intervals for each media object. For example, the first video media object is intended to be played during an initial time interval 878 and during a final time interval 879. Once a user has finished specifying play intervals for each media object, input to the navigation feature 880 results in display of a review page, next discussed with reference to FIG. 8F.

FIG. 8F shows a review page 881 that includes a large display or presentation window 882 that allows a user to review the multi-media product or service review that the user has composed via the previously discussed review-composition page 855 shown in FIG. 8D and the timeline page 871 shown in FIG. 8E. Input feature 883 allows a user to start and stop display of the multi-media review. In general, the review window includes multiple-windowing capabilities to allow multiple media objects to be concurrently rendered and displayed, according to the defined play intervals. Input features 884-887 allow the user to submit the multi-media review to the distributed review-aggregation system, save the multi-media review locally, continue editing the multi-media review, or delete the multi-media review.

FIG. 8G shows a feedback page displayed by the client-side application following response to submission of a review by the user to the distributed review-aggregation system. The feedback page 888 displays an overall rating 889 and valuation 890 for the submitted review as well as individual ratings 891-895 for the review topic and for each of the different media objects included in the review. In addition, comments and an analysis of the submitted review are displayed in display windows 896 and 897. Finally, a consent form or agreement is displayed in display window 898 which, when accepted by the user, acts as an agreement or contract for transfer of all or a portion of the rights of the review to the distributed review-aggregation system. The agreement is accepted by user input to the submit feature 899.

As mentioned above, there are many different possible user interfaces that can be provided by the client-side application components of a distributed review-aggregation system. In certain cases, a much more sophisticated review-authoring subsystem may be provided, allowing for editing the content of media objects, overlaying graphics onto displayed media objects, definition and population of subframes and subwindows within the overall review presentation, and many other such editing features. In general, however, the currently described user interface employs simple and basic composition tools with the assumption that the review will be processed and packaged by retailer purchasers for display on their websites or kiosks and/or processed and packaged by the distributed review-aggregation system for display to accessing entities. In other words, in the described implementation, a user provides the basic review content and sophisticated packaging, formatting, and presentation of the content is carried out either by the distributed review-aggregation system or by purchasers of the review. In very complex and highly functional implementations, a full suite of multi-media-production tools and applications may be bundled with the client-side application to allow sophisticated users to prepare production-level reviews for submission to the distributed review-aggregation system.

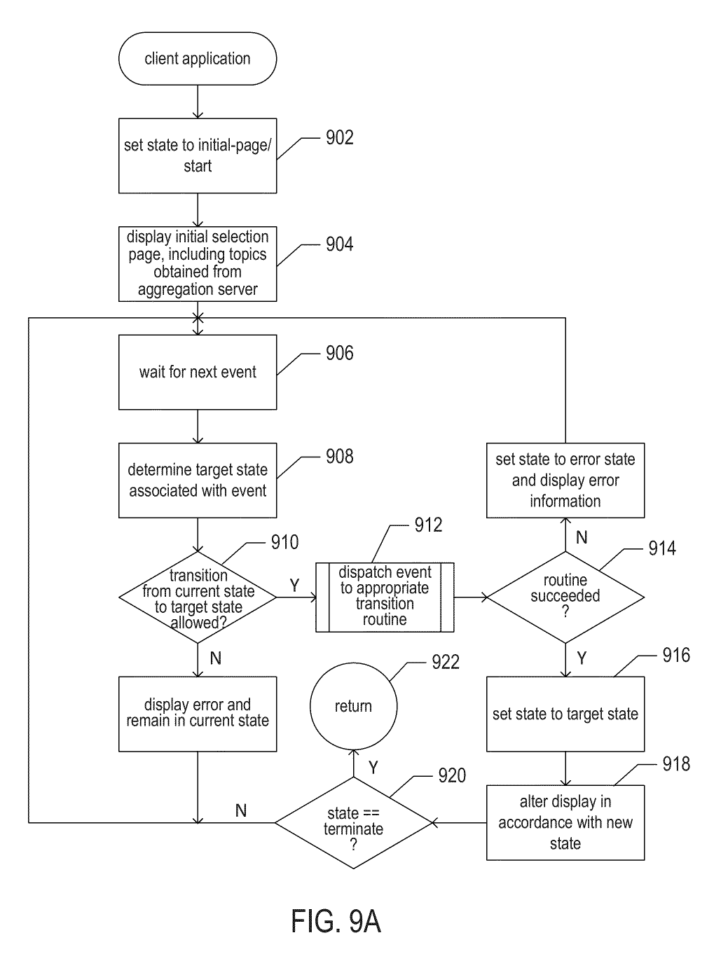

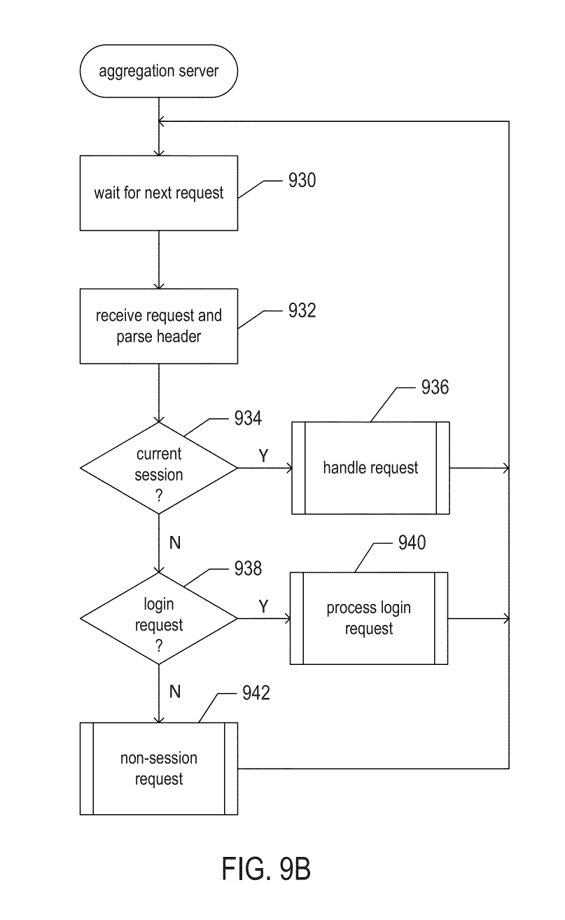

FIG. 9A-B provide general descriptions of the implementation of the client-side-application and aggregation-server components of the distributed review-aggregation system. FIG. 9A shows a control-flow diagram for the inner loop of the client-side application. In step 902, after being launched by a device operating system, the client-side application sets a current-state variable to indicate that the client application is in an initial-page/start state. In this implementation, the client application transitions from one state to another as events, including user inputs, occur. The overall state of the client application includes the currently displayed user-interface page and a local state relevant to the currently displayed page. Next, in step 904, the client application displays the initial page discussed above with reference to FIG. 8A. Then, in step 906, the client application waits for the occurrence of a next event. In general, events include user input and reception of communications messages transmitted by the aggregation server, but may include other types of events passed to the client application by the operating system. When a next event occurs, the client application determines a target state associated with the event, in step 908. When transition from the current state to the target state is allowed, as determined in step 910, then, in step 912, the client application dispatches the event to an appropriate event-handling/state-transition routine. When the routine succeeds, as determined in step 914, then the current state of the client application is set to the target state, in step 916 and, in step 918, the user-interface display may be altered in accordance with the state transition. When the current state is a terminate state, as determined in step 920, then the client application shuts down, as represented by the return statement 922. Otherwise, control returns to step 906 to wait for a next event. When the event-handling/transition routine fails, as determined in step 914, the current state of the client application is set to an error state and error information is displayed in the user interface followed by a return to step 906 to wait for a next event. When transition from the current state to the target state is not allowed, as determined in step 910, then an error is displayed, but the client-application remains in a current state and returns to step 906 to wait for a next event.

In practical implementations, the basic inner loop of the client application may be somewhat more complex, since events may occur at a higher rate than they can be handled. In general, events are queued according to priority for subsequent handling. Moreover, many state transitions may occur in response to a particular event before a return to the wait step 906. In certain implementations, the state of the client-side application may be implicit, rather than explicit.

FIG. 9B provides a control-flow diagram that illustrates the basic operation of the aggregation server. In step 930, the aggregation server waits for a next request. When a next request is received, the aggregation server, in step 932, receives the request from the operating system and parses a header included in the request message. When the request is a next request within the context of a current session, as determined in step 934, then the request is handled in step 936 in the context of that session. When the request is a login request, as determined in step 938, then the login request is processed in step 940, one effect of which is to create a session for the user requesting login. Other non-session-related and non-login requests, including registration requests and requests for help information, are processed in step 942. Thus, the aggregation server, in general, waits for and processes incoming requests on behalf of user-controlled remote client-side applications.

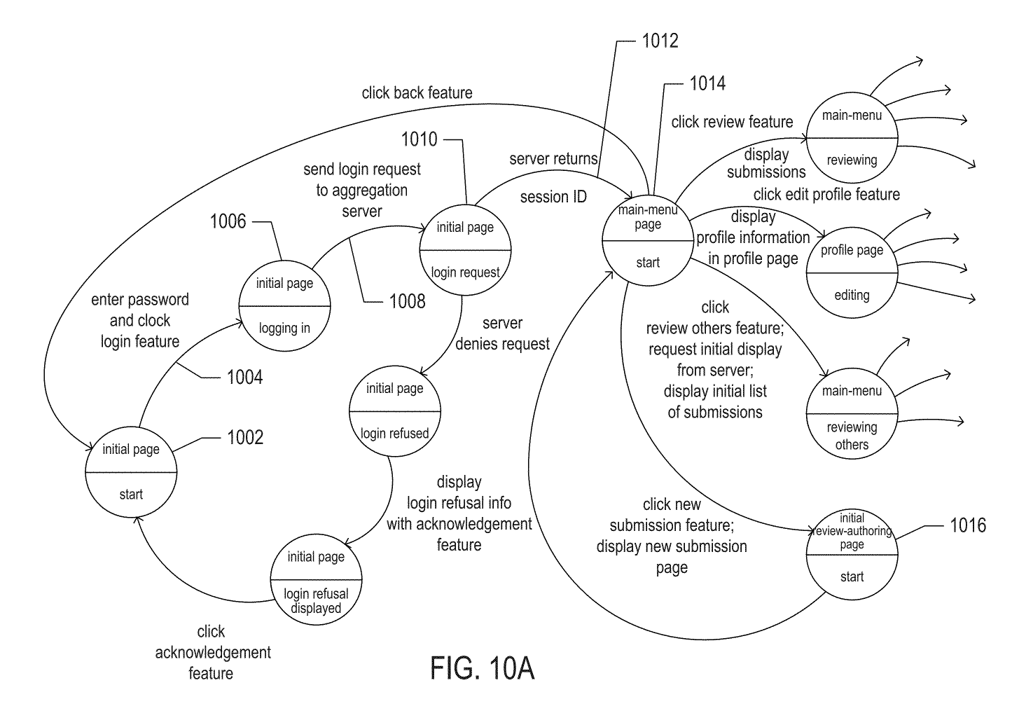

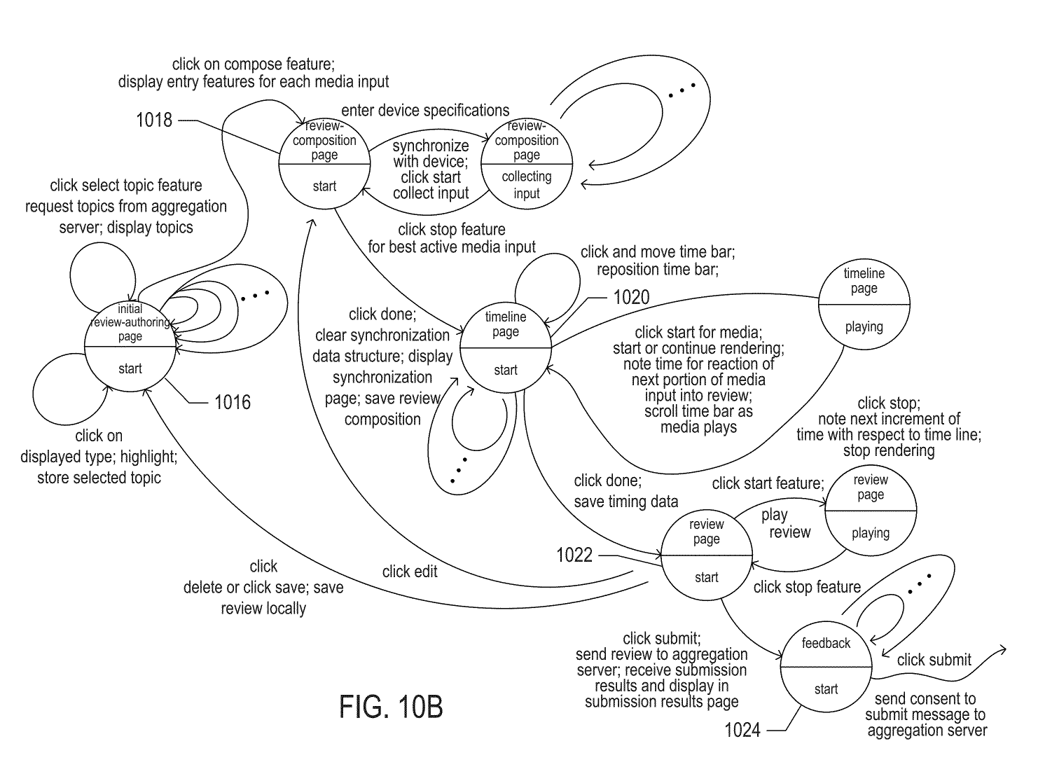

Practical implementations of the client-side application are, as with any large software system, generally complex and not amenable to brief descriptions, but instead comprise many modules and routines that, when executed by one or more processors, control a user device to display various different interface pages to the user, collect information and media objects from the user and the user's devices, and communicate with a remote aggregation server. One method for describing complex electronic systems, such as a user device controlled by the client-side application, is to use state-transition diagrams. FIGS. 10A-B provide a small portion of an example state-transition diagram for a client-side application component of a distributed review-aggregation system. Considering the portion of the state transition diagram shown in FIG. 10A, states are represented by disk-shaped nodes, such as disk-shaped node 1002 and transitions are represented as curved arcs that emanate from one node and lead to another node, such as arc 1004 that leads from node 1002 to node 1006. Each node includes an indication of the currently displayed user-interface page and a local state relevant to that page. For example, node 1002 indicates that the initial page, discussed above with reference to FIG. 8A, is currently displayed and that the client-side application currently resides in a local start state relevant to that initial page. State transitions are generally caused by events, including user input, received communications messages, and other events passed to the client-side application by the operating system. For example, when a user enters a password into the password-input feature 808 shown in FIG. 8A and inputs a mouse click to the login feature 804 shown in FIG. 8A, a transition represented by arc 1004 occurs to the state represented by node 1006, in which the client-side application constructs a login-request message. The transition represented by arc 1008 occurs when the client-side application sends the login request message to an aggregation server, with the client-side application then residing in a state represented by node 1010 in which the login request has been made and the client-side application waits for the aggregation server to return a response to the request. When the login succeeds, and the aggregation server returns a session ID in a response message to the client-side application, represented by transition 1012, then the client-side application displays the main-menu page, discussed above with reference to FIG. 8C, and inhabits a state represented by node 1014. Additional nodes in the partial state-transition diagram shown in FIGS. 10A-B include nodes representing an initial state after display of the initial review-authoring page 1016, discussed above with reference to FIG. 8C, an initial state following display of the review-composition page, discussed above with reference to FIG. 8D, represented by node 1018, an initial state following display of the timeline page, discussed above with reference to FIG. 8E, represented by node 1020, an initial state following display of the review page, discussed above with reference to FIG. 8F, represented by node 1022, and an initial state following the display of the feedback page, discussed above with reference to FIG. 8G, represented by node 1024. Of course, in a practical implementation of the distributed review-aggregation system, the state-transition diagram for the client-side application contains many more states and state transitions, just as the user interface contains many pages in addition to the pages discussed above with reference to FIGS. 8A-G. For example, once a user submits a review for distribution to retailers and other entities, via input to the submit input feature shown in FIG. 8G, additional pages may be displayed to the user to indicate acceptance by the distributed review-aggregation system and to transfer payment or credits to the user in return for the review. Additional pages and facilities may be provided by the client-side application to allow a user to monitor and receive additional payments following purchase or renting of reviews by retailers and other entities once the reviews are published by the distributed review-aggregation system.

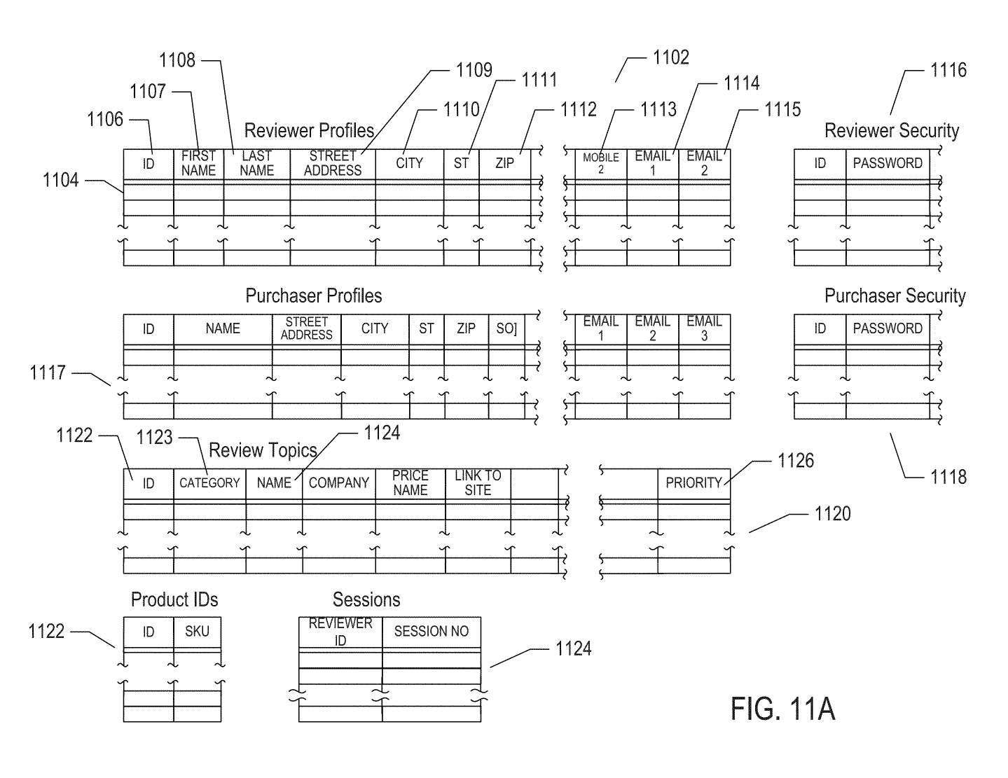

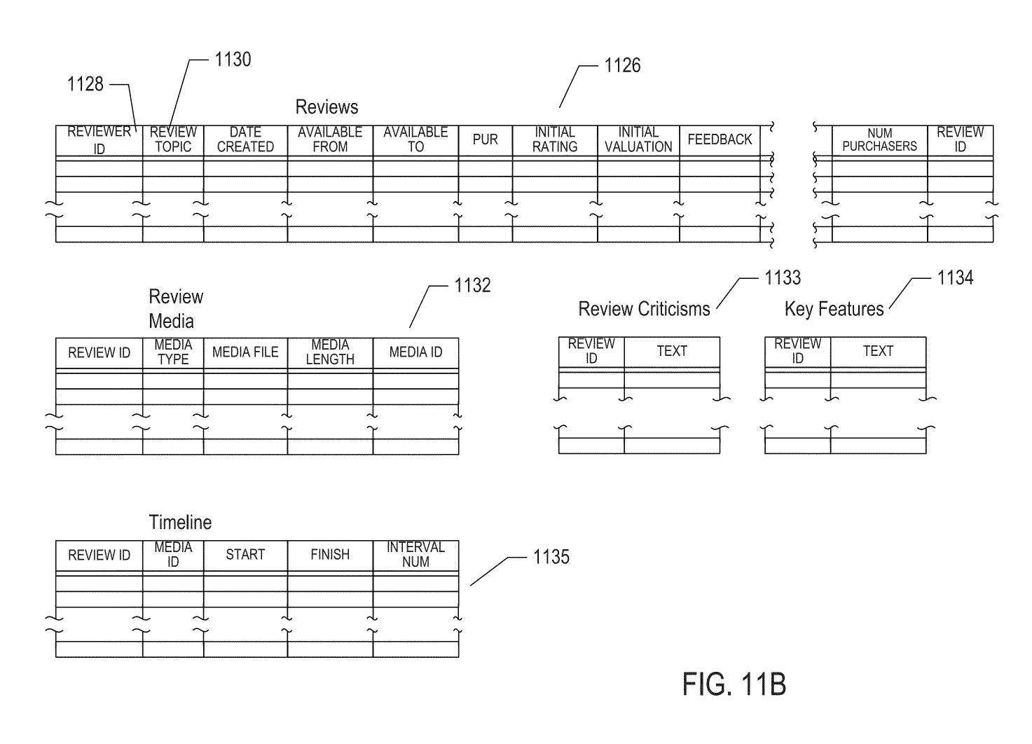

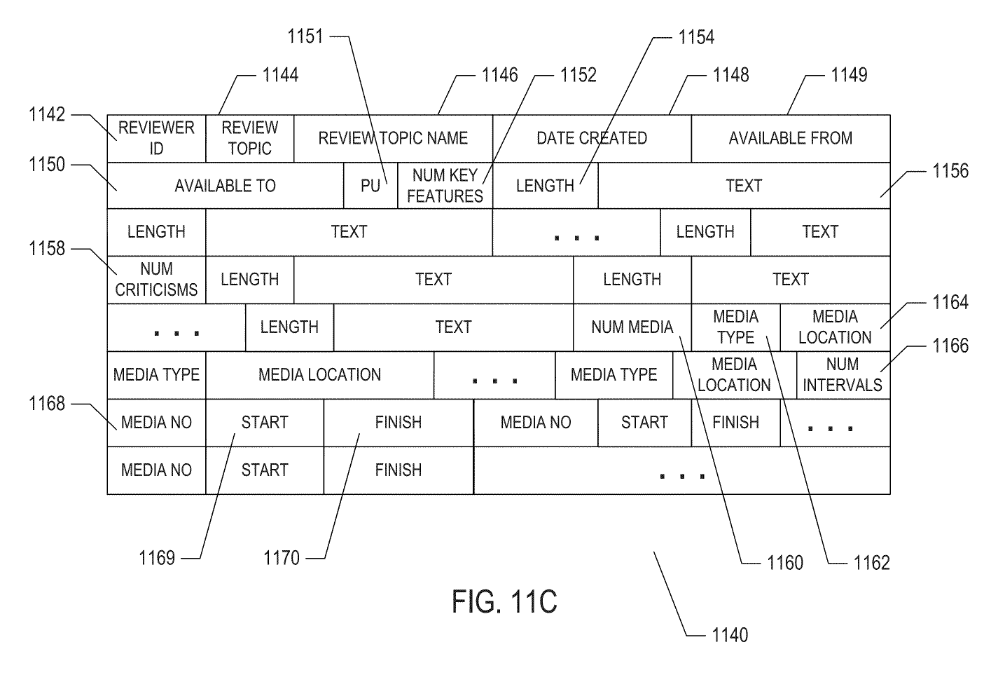

There are many different possible ways to implement the aggregation servers, just as there are many different possible implementations of the client-side application. In one implementation, the aggregation server stores reviews and reviewer profiles in relational database tables. FIGS. 11A-B illustrate a portion of the relational database tables that may be constructed and used by certain implementations of the aggregation server. A reviewer-profiles table 1102 may be used to store information about reviewers. Each row in the table, such as the first row 1104, includes the information for a particular reviewer. The columns of the table correspond to fields within an entry or record for a particular reviewer. In FIGS. 11A-B, only a few of the fields are shown from many of the tables, in the interest of brevity and clarity of illustration. A reviewer may be described by a unique reviewer ID 1106, first and last names 1107-1108, a street address 1109, city of residence 1110, state of residence 1111, zip code 1112, a mobile phone number 1113, a first email address 1114 and a second email address 1115. A separate reviewer-security table 1116 may store passwords for each reviewer represented by a reviewer ID. A purchaser-profiles table 1117 and purchaser-security table 1118 store similar information for retailers and other clients of the distributed review-aggregation system. Information about review topics is a stored in a review-topics table 1120. The information may include a unique ID for the review topic 1122, a category 1123 for the review topic, a name for the review topic 1124, and additional information, including a priority 1126 associated with the review topic. Higher-priority review topics are those review topics for which there is a large demand from retailers and other entities accessing the distributed review-aggregation system. A separate table 1122 may store codes for products corresponding to review topics and another table 1124 may store session numbers for currently accessing reviewers. A reviews table 1126, shown in FIG. 11B, includes entries that represent reviews submitted by reviewers. Fields within an entry of record describing a review include the reviewer ID of the reviewer submitting the review 1128, the topic of the review 1130, and other such information collected through the review-authoring pages discussed above with reference to FIG. 8C. In addition, separate tables 1132-1135 store descriptions of the media objects included in each review, review criticisms and key features associated with the review, and intervals for media objects with respect to a timeline for the review. In some implementations, when the media object includes a text portion, the description of this media object is generated by the system using this text portion of the media object. In some implementations, when the media object includes an audio component, the system performs speech recognition analysis of the audio component and generates the text portion based on this analysis. In some implementations, the system applies semantic analysis to the text portion of the media object to generate the description.

FIG. 11C shows a representation of a multi-media-review-package data structure transferred from the client-side application to the aggregation server when a review is submitted by a reviewer to the distributed review-aggregation system. The multi-media-review-package data structure 1140 includes the identifier for the reviewer 1142, an encoding of the review topic 1144, the review-topic name 1146, additional metadata associated with the review 1149-1151, one or more key features, the number of which is indicated by the value in field 1152, with each key feature represented by a length 1154 and a following text string of that length 1156. Similarly, criticisms associated with the review are included in a list of criticisms that begin with a number of criticisms 1158. Field 1160 indicates the number of media objects included in the review. Each media object is represented by an indication of the media type 1162 and an indication of an address or location from which the media object can be downloaded or streamed 1164. Finally, field 1166 indicates the number of timeline intervals specified by the user, with each interval represented by an indication of the media object 1168, a start time 1169, and a finish time 1170. As with the above-described relational-database tables, user-interface pages, and state-transition diagrams, a particular implementation of the multi-media-review-package data structure may include many additional fields representing additional types of metadata and additional data related to media objects.

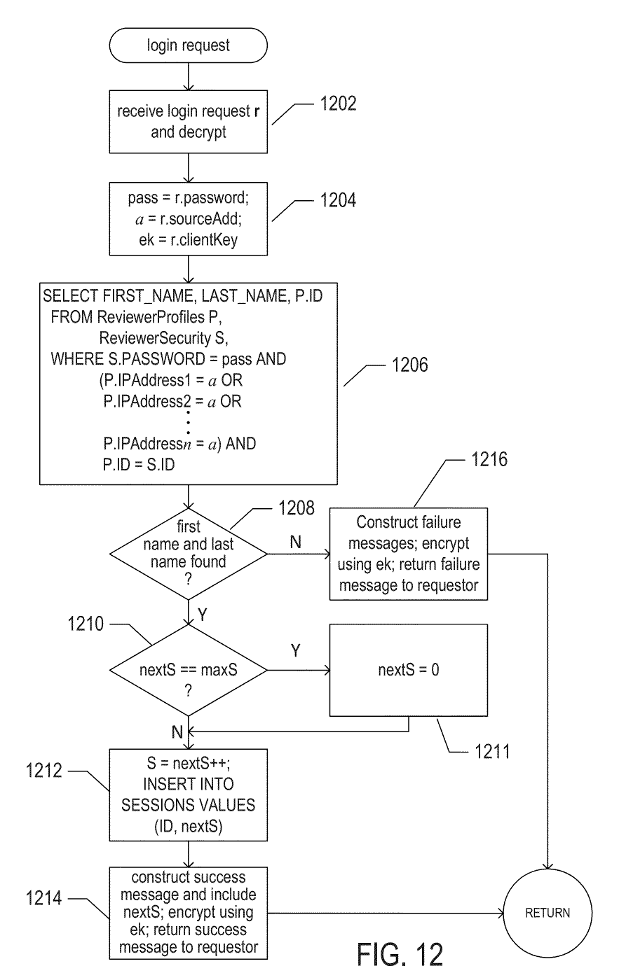

FIGS. 12-16 illustrate, using control-flow diagrams, aggregation-server handling of various types of requests. FIG. 12 illustrates handling of a login request received by an aggregation server. In step 1202, the aggregation server receives the login request and decrypts the contents of the request using the aggregation server's private key of a public/private key pair. In step 1204, the aggregation server extracts a password, source address, and client key from the login-request message. In step 1206, the aggregation server attempts to find an entry for the requesting user in the reviewer-profiles table and a matching password in the reviewer-security table. When an entry is found, as determined in step 1208, then, in steps 1210-1212, the aggregation server generates a new session ID or session number for the user and inserts the new session number into the sessions table. In step 1214, the aggregation server constructs a success message with which to respond to the login request, the success message including a session number generated for the user and, in certain implementations, the reviewer ID associated with the user, encrypts the success message using the client's key extracted from the login-request message, and returns the success message to the requestor. When an appropriate entry cannot be found in the reviewer-profiles table and reviewer-security table for the login request, a failure message is constructed, in step 1216, and returned to the client-side application from which the login-request message was received.

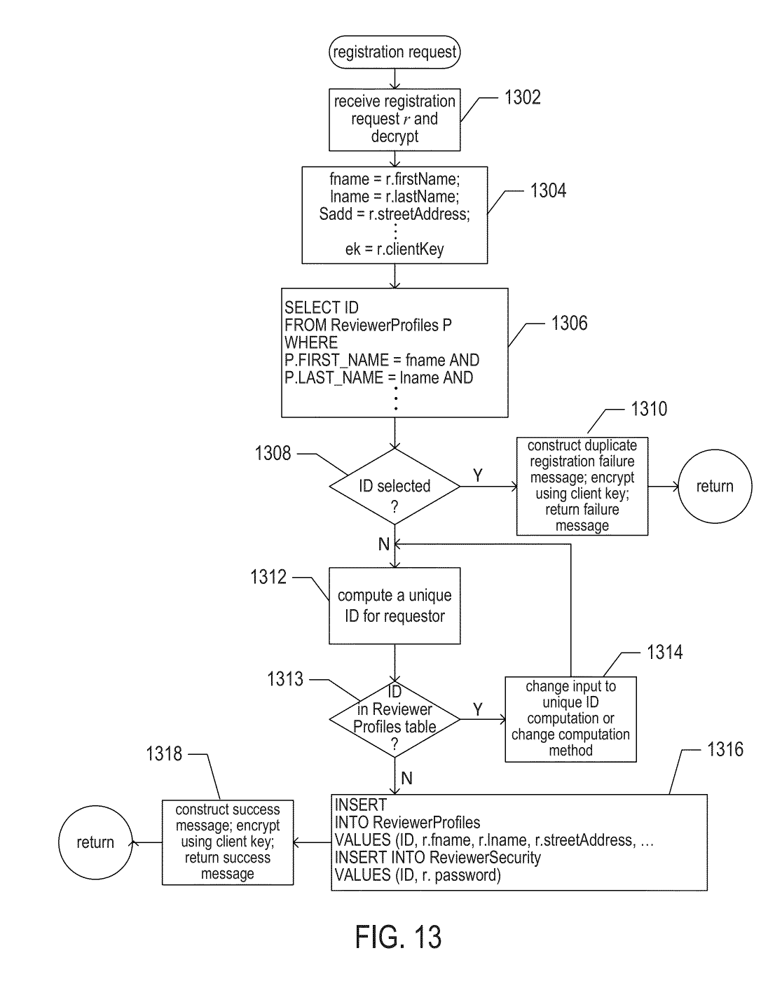

FIG. 13 provides a control-flow diagram that illustrates handling of a registration request by the aggregation server. In step 1302, the aggregation server receives a registration-request message and decrypts the message using the aggregation server's private key. In step 1304, the aggregation server extracts various types of profile information included in the registration-request message as well as a client key from the received registration-request message. In step 1306, the aggregation server attempts to find a matching profile already resident within the reviewer-profiles table. When a matching entry is found, as determined in step 1308, then the aggregation server constructs a duplicate-registration-failure message, in step 1310, and returns the failure message to the client-side application from which the registration-request message was received. Otherwise, the aggregation server computes a new unique reviewer ID for the user in step 1312-1314. In step 1316, the aggregation server inserts information for the user into the reviewer-profiles table and reviewer-security table. Finally, in step 1318, the aggregation server constructs a success-message to return to the client-side application in response to this received registration-request message.

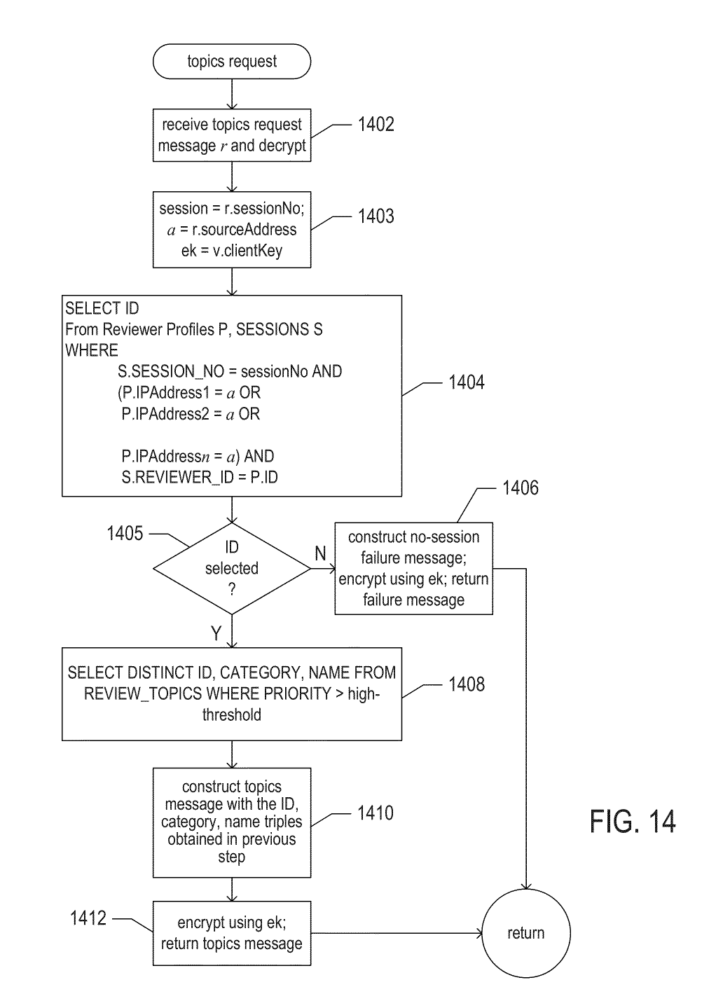

FIG. 14 provides a control-flow diagram for handling of a topics request by an aggregation server. In steps 1402-1405, the aggregation server receives the topics request and determines whether or not the requesting user is currently logged in and is making the request in the context of the current session. When there is no session or profile entry for the user, then, in step 1406, the aggregation server constructs a no-session failure message and returns it to the requesting client-side application. Otherwise, the aggregation server retrieves a list of metadata-description of the highest-priority review topics from the review-topics table, in step 1408 and returns the retrieved topics in a topics message constructed in step 1410 and encrypted in step 1412.

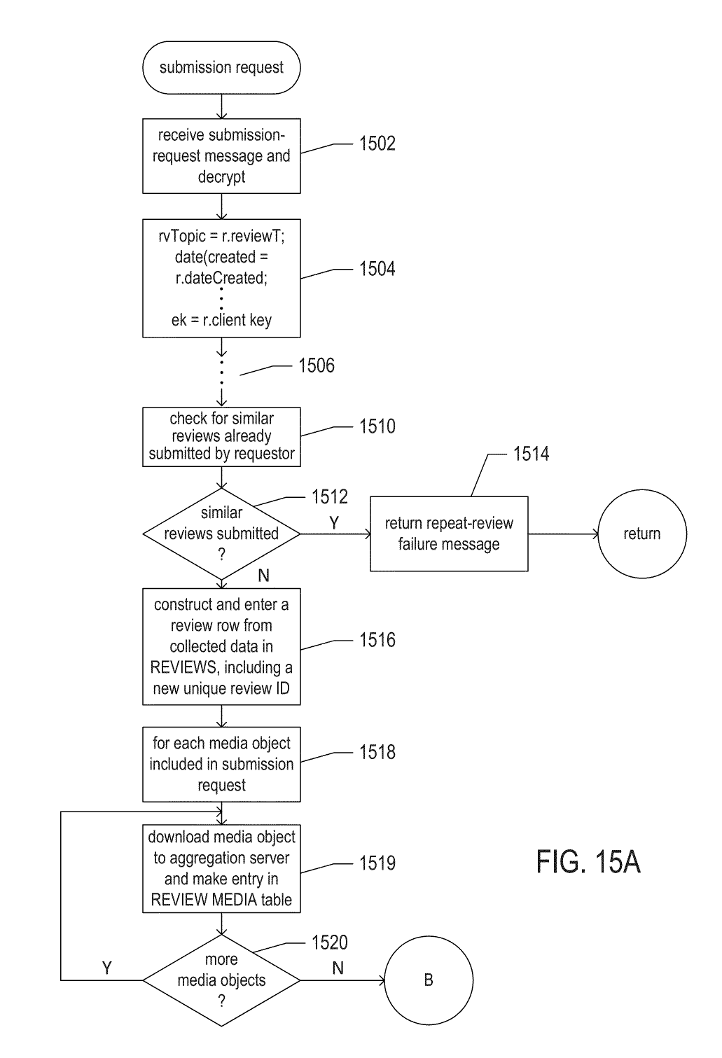

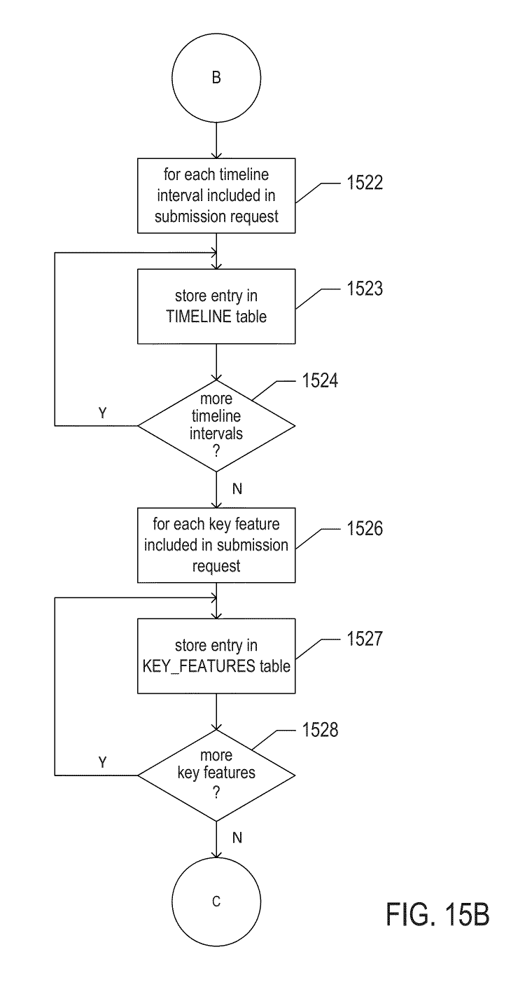

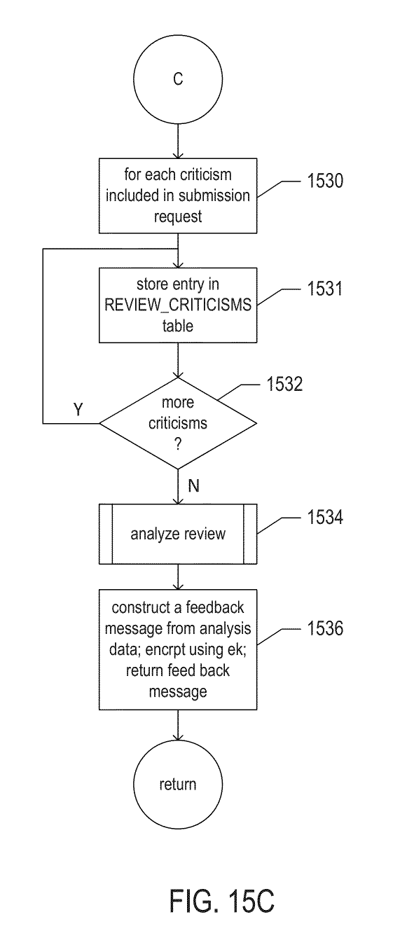

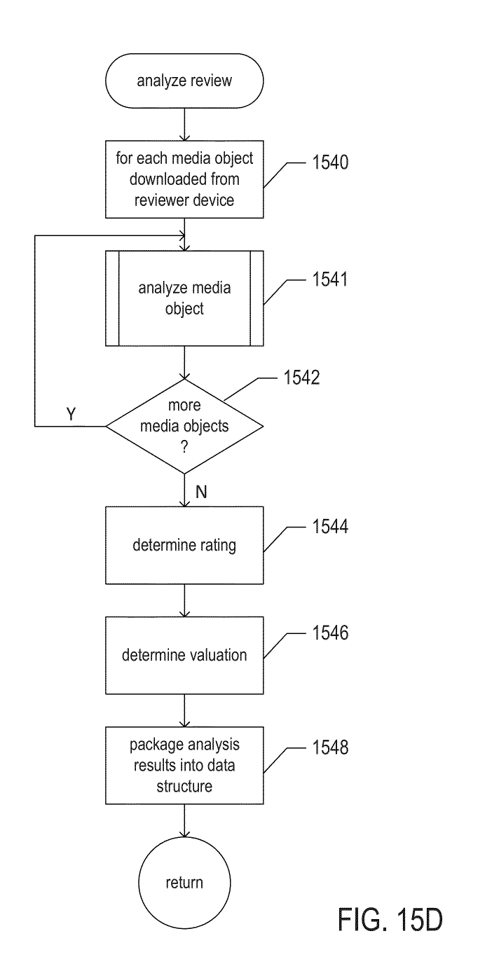

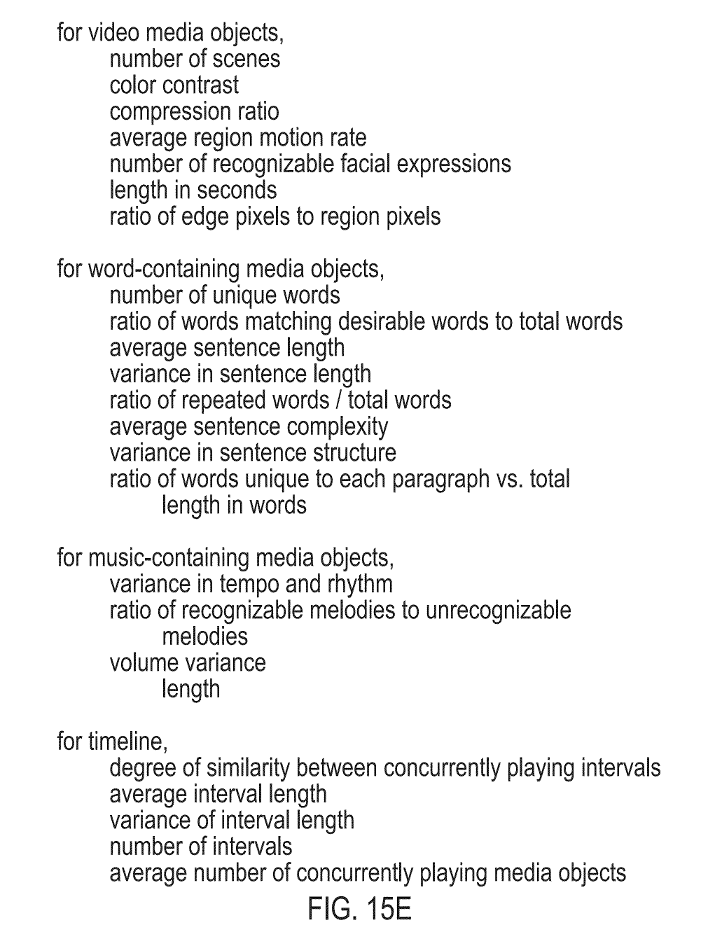

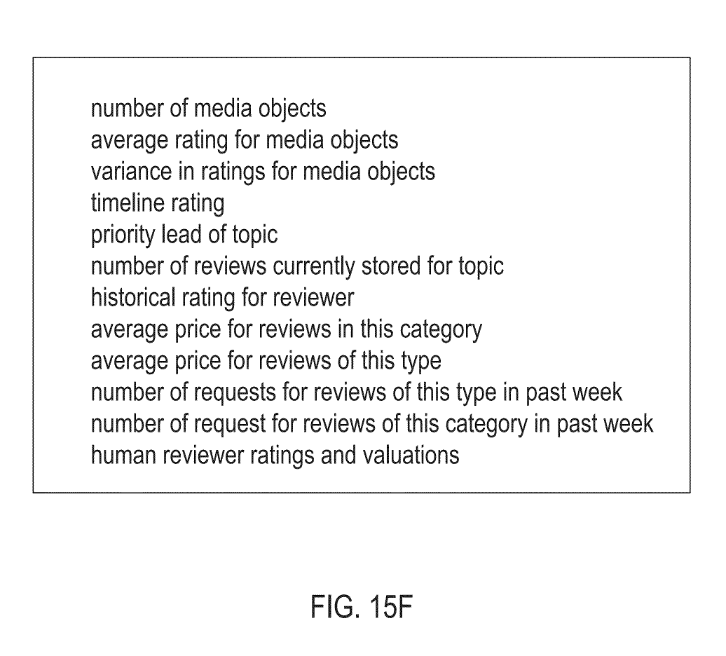

In FIGS. 15A-D, a control-flow diagram for handling of a review-submission request by the aggregation server is provided. In step 1502 in FIG. 15A, the aggregation server receives a submission-request message and decrypts the message. In step 1504, the aggregation server extracts metadata from the multi-media-review-package data structure included in the submission-request message as well as a client key. In additional steps represented by ellipsis 1506, the aggregation server determines whether or not the submission-request message has been sent in the context of an active session. When not, a failure message is returned. These steps are similar to steps 1404-1406 in FIG. 14. Next, in step 1510, the aggregation server checks for similar reviews already submitted by the requester residing in the reviews table. This can be carried out by a query that partially matches metadata information extracted from the submission-request message in step 1504 to data contained in entries of the review table. When one or more similar reviews have already been submitted, as determined in step 1512, then the aggregation server returns a repeat-review-failure message in step 1514. Otherwise, the aggregation server generates a new unique review ID for the submitted review and constructs an entry for the submitted review in the reviews table using extracted information, in step 1516. In thefor-loop of steps 1518-1520, the aggregation server downloads or streams each media object described in the multi-media-review-package data structure, locally stores the media object, and enters an entry into the review-media table describing the media object. Similarly, in steps 1522-1524 shown in FIG. 15B, timeline intervals specified in the multi-media-review-package data structure are extracted and corresponding entries are stored in the timeline table. In thefor-loop of steps 1526-1528, key features included in the multi-media-review-package data structure are extracted and stored in the key-features table. In thefor-loop of steps 1530-1532 shown in FIG. 15C, criticisms included in the multi-media-review-package data structure are extracted and stored in the review-criticisms table. In step 1534, the aggregation server analyzes the submitted review and, in step 1536, constructs a feedback message containing data from the analysis that is display to the submitting reviewer by the client-side application in the feedback page discussed above with reference to FIG. 8F.

FIG. 15D provides a control-flow diagram for the routine “analyze review,” called in step 1534 of FIG. 15C. In thefor-loop of steps 1540-1542, the routine “analyze review” analyzes each media object in order to determine a rating for each of the media objects. In step 1544, the routine “analyze review” determines an overall rating for the submitted review which may include separate, component ratings for the review topic and other aspects of the review. In step 1546, the routine “analyze review” determines an initial valuation for the submitted review. Finally, in step 1548, the routine “analyze review” packages the results of analyzing the individual media objects and the submitted review as a whole into a data structure that is returned to the client-side application that submitted the review.

In general, analysis of a submitted review and the media objects contained in the submitted review may involve computation of many intermediate values and combining these intermediate values, often with weight multipliers, to produce a final numerical rating. The intermediate values may also generate natural-language comments and analyses that may be included in feedback returned to a user in response to submission of a review. FIG. 15E lists a number of the different intermediate values that may be computed during analysis of particular media objects and the timeline intervals that describe how playback of the media objects are synchronized. Many of these intermediate values can be generated by computational analysis of submitted media objects. For example, for video media objects, video-analysis modules may determine the number of discrete scenes included in the video, compute numeric values that reflect the amount of color contrast in each of the scenes and in the video, in general, compute a compression ratio for the video object, which is indicative of the information content of the video, the average rate of motion of discrete regions within the video scenes by computing motion vectors for the regions, a number of recognizable different facial expressions exhibited by people in the video, the length of the video in seconds, and the ratio of edge pixels to region pixels within the video. Many other such computed values and metrics can be automatically generated by video-analysis modules. In combination, these values may be used to estimate the information content of the video, the likely appeal of the video to viewers of the video, and other such higher-level characteristics that can be combined together to produce an overall numerical rating value. FIG. 15E shows various additional examples of metrics that may be computed for word-containing media objects, such as text files, music-containing media objects, and for the timeline intervals that describe when media objects are displayed or presented during the review.

FIG. 15F shows various different types of intermediate results that may be computed in order to determine an overall rating for a review as well as a valuation for the review. As with the ratings determined for individual media objects, the rating and valuation for the review, as a whole, is generally based on a weighted combination of many such lower-level numerically represented characteristics and considerations. In certain implementations, ratings may be provided by human review analysts in addition to computational processing of submitted reviews.

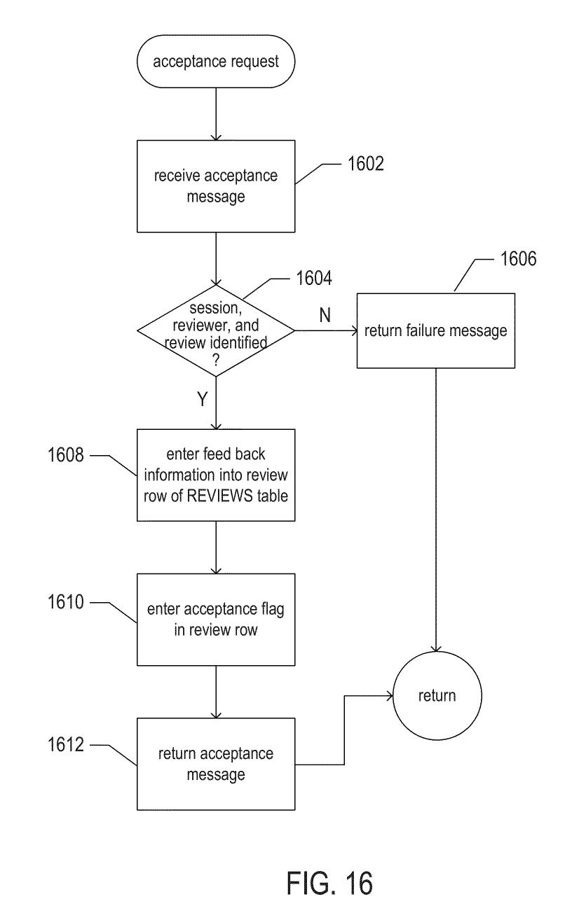

FIG. 16 provides a control-flow diagram for a routine that handles final acceptance or submission requests generated as a result of user input to the submit input feature shown in FIG. 8G. In step 1602, the aggregation server receives an acceptance or a final submission message from a client-side application. The aggregation server then verifies that this message includes identification of a current session, the reviewer interacting with the distributed review-aggregation system via the session, and an identifier for a submitted review. When this cannot be verified, as determined in step 1604, then a failure message is returned to the client-side application in step 1606. Otherwise, the feedback information provided to the reviewer in a previously sent message is inserted into the row of the reviews table representing the submitted review, in step 1608. Then, an acceptance flag is set for the review in step 1610, with the acceptance flag corresponding to a column in the reviews table. Finally, in step 1612, an acceptance acknowledgement message is returned to the client-side application. Subsequently, the server aggregator may, in a separate transaction, transmit credits or other remuneration to the reviewer in return for the right to distribute the review to retailers and other interested parties.

### Review-Distribution System

Once the distributed review-aggregation system accumulates multi-media reviews, as discussed above, the aggregated reviews are distributed to potential purchasers, licensees, and viewers by a review-distribution system. In certain cases, a review-distribution system is incorporated into the review-aggregation system. In other cases, aggregated reviews are transferred by the review-aggregation system to third-party storage systems, from which they are obtained for distribution by a review-distribution system, or transferred directly to the review-distribution system by the review-aggregation system. The following discussion of the review-distribution system pertains either to a review-distribution-system component of a combined review-aggregation and review-distribution system or to a separate review-distribution system.

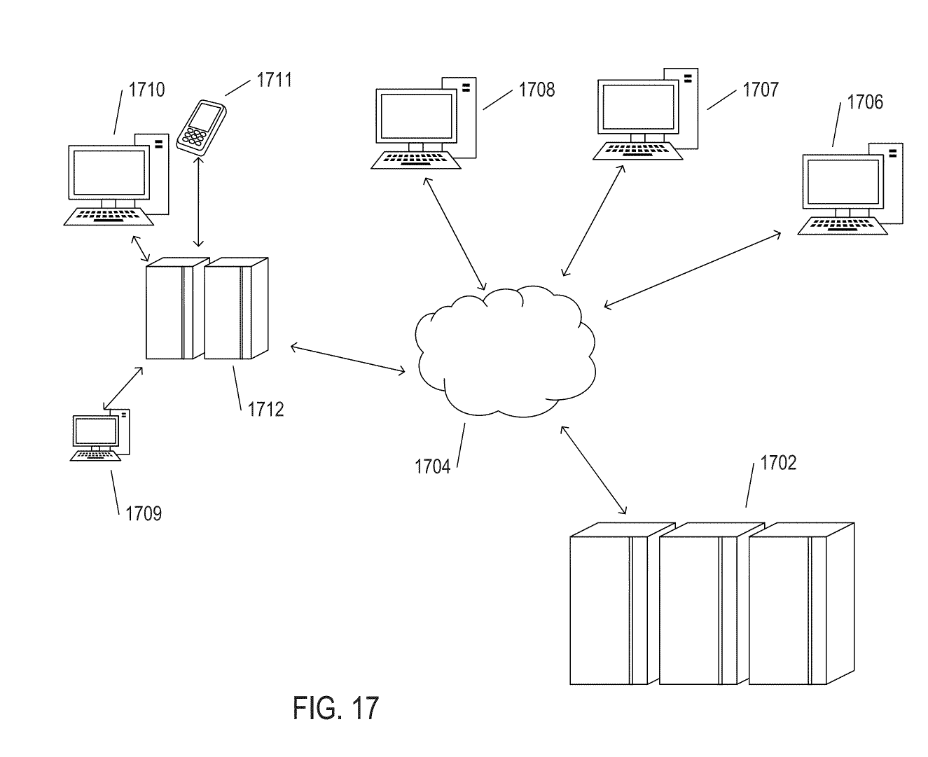

FIG. 17 illustrates the general operational environment of the review-distribution system. The review-distribution system 1702 may be a private data center, a cloud-computing facility, a virtual data center within a cloud-computing facility, or other types of computing facilities. The review-distribution system is accessible through the Internet 1704 to a wide variety of different types of clients that access the review-distribution system through a web-page interface from any of various different types of user computers and appliances 1706-1711. These users may include web-site owners and managers who wish to purchase or license reviews for display on web pages, various types of search firms that provide search engines that allow search-engine users to find and access reviews on various products, social-networking organizations, and other users, viewers, and secondary distributors of multi-media reviews. For example, in FIG. 17, a search-engine or social-networking data center 1712 may purchase or license reviews from the review-distribution system 1702 via a web-page-based interface displayed to a system-administrator's computer 1709, or by various automated review-feed technologies, for distribution to clients 1710 and 1711 of the search engine or social network. The review-distribution system, in certain implementations, comprises a large number of distribution servers, each of which services requests from clients of the review-distribution system.

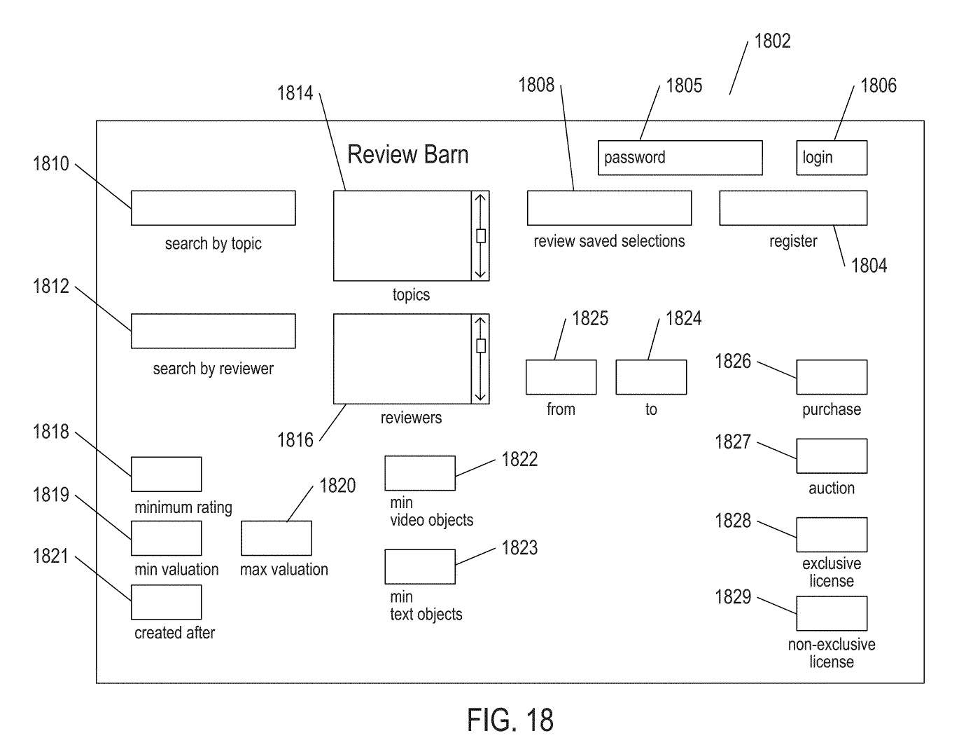

FIGS. 18-22 illustrate a portion of an example web-page-based user interface provided by the review-distribution system to clients of the review-distribution system. FIG. 18 illustrates an example initial request page. The initial request page 1802 includes registration and login features 1804-1806 similar to those discussed above with reference to the initial page shown in FIG. 8A. In addition, the initial request page 1802 includes a review-saved-selections feature 1808, input to which results in display of a selections-review page that allows a user of the review-distribution system to review previously made selections of multi-media reviews for bid, purchase, or licensing. User input to either of two search features 1810 and 1812 results in a search for multi-media reviews by the review-distribution system and display of the search results via a search-results page. The two search features allow a user to search for reviews by product/service being reviewed, by reviewer who prepared the review, by category and/or price of the product/service being reviewed, by the time when the review was created, by the review's sentiment and content, etc. A display feature 1814 displays a list or catalog of topics and a display feature 1816 displays a list or catalog of reviewers. Entries displayed in display features 1814 and 1816 can be imported into the search-by-topic feature 1810 and search-by-reviewer feature 1812 to facilitate launching searches for multi-media reviews. In addition, a variety of different input features 1818-1829 are provided to allow a user to specify various parameters and criteria for reviews that they are searching for. The input features 1818-1829 shown in the initial request page 1802 represent only a few of many possible criterion-and-parameter input features for refinement of search requests. The input features 1818-1829 shown in FIG. 18 include: (1) a minimum-rating feature 1818 that allows a user to indicate the minimum rating desired for reviews returned by the search; (2) min-valuation and max-valuation input features 1819-1820 that allow users to specify the minimum and maximum initial valuations for reviews returned by the search; (3) a created-after input feature 1821 that allows a user to specify a threshold date for creation for reviews returned by the search; (4) a minimum number of video objects input feature 1822 that allows a user to specify the minimum number of video objects within a multi-media review returned by the search; (5) a minimum number of text objects input feature 1823 similarly allows a user to specify a minimum number of text objects within multi-media reviews returned by the search; (6) from and to input features 1824-1825 that allow a user to indicate a desired period of use or licensing for multi-media reviews returned by the search; and (7) input features 1826-1829 that allow a user to indicate whether the user wishes to receive, in the search results, reviews available for purchase, auction, exclusive license, and/or non-exclusive license.

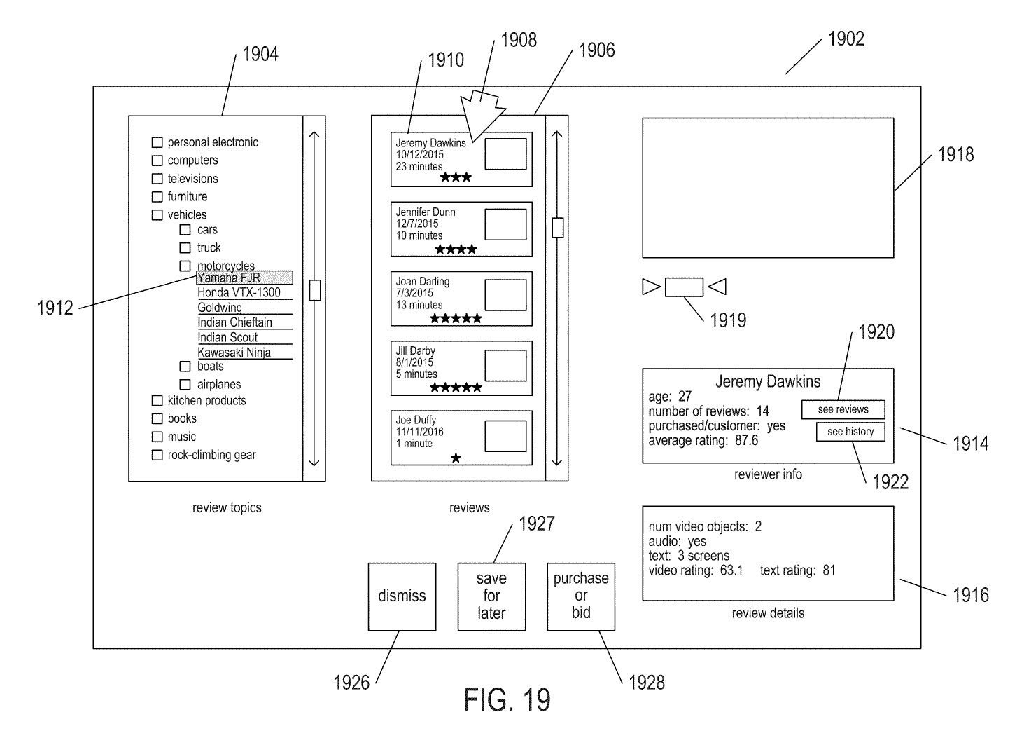

FIG. 19 shows an example search-results page displayed to a user following a search request made from the initial request page discussed above with reference to FIG. 18. The search results page 1902 includes a display feature 1904 that displays, in outline form in one implementation, review topics of the reviews returned by a search and displayed on the review-results page. A second display feature 1906 displays a list of thumbnail-type representations of the reviews returned by the search. When a user inputs a mouse click to a thumbnail, as represented in FIG. 19 by the cursor image 1908 overlying thumbnail 1910, the topic of the review is highlighted 1912 in the review-topics display feature 1904 and additional information about the selected review is shown in display features 1914 and 1916. A user may play the multi-media review represented by thumbnail 1910 in the multi-media-review-rendering feature 1918-1919. The multi-media review may be transmitted to the user device via transmission of a multi-media-review-package data structure, followed by transmission of subsequently requested media objects. Alternatively, the multi-media review may be transmitted as a compressed media file, such as an MPEG file. Information display window 1914 displays information about the reviewer who generated the review and includes additional input features 1920 and 1922 that allow a user to view other reviews created by the same reviewer and to review the reviewers purchasing and review-distribution history 1922, respectively. Information-display feature 1916 displays additional details about the selected review, including the number of various types of media objects, various types of ratings, and other such information. Input features 1926-1928 allow a user to dismiss or delete a selected review from the results list, save one or more selected reviews for later review by the user, or purchase or bid on the selected review, respectively.

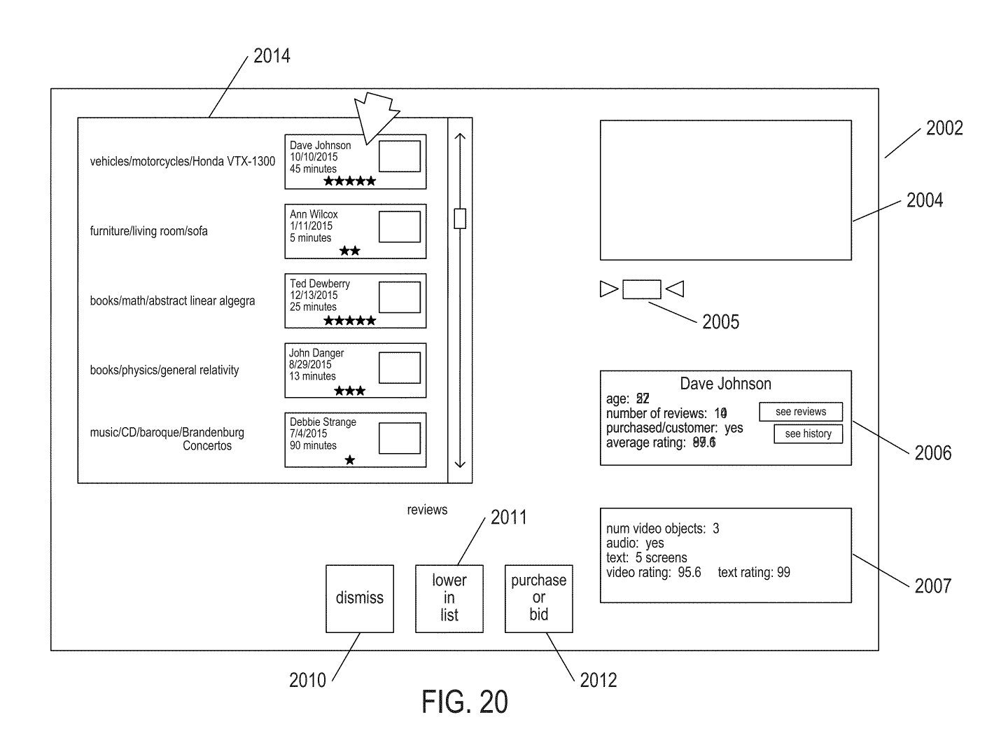

FIG. 20 illustrates a selections-review page. The selections-review page 2002 is displayed in response to user input to the review-saved-selections feature 1808 in the initial request page shown in FIG. 18. The selections-review page 2002 includes many of the same display and input features provided by the search-results page discussed above with reference to FIG. 19, including the multi-media-review-rendering features 2004-2005, information-display features 2006 and 2007, and input features 2010 and 2012. Input feature 2011 allows a user to change the position of a review in the list of selected or saved reviews. The selections-review page 2002 includes a combined selections-display feature 2014 that displays thumbnail descriptions of previously saved reviews along with indications of the topics of each of the saved reviews.

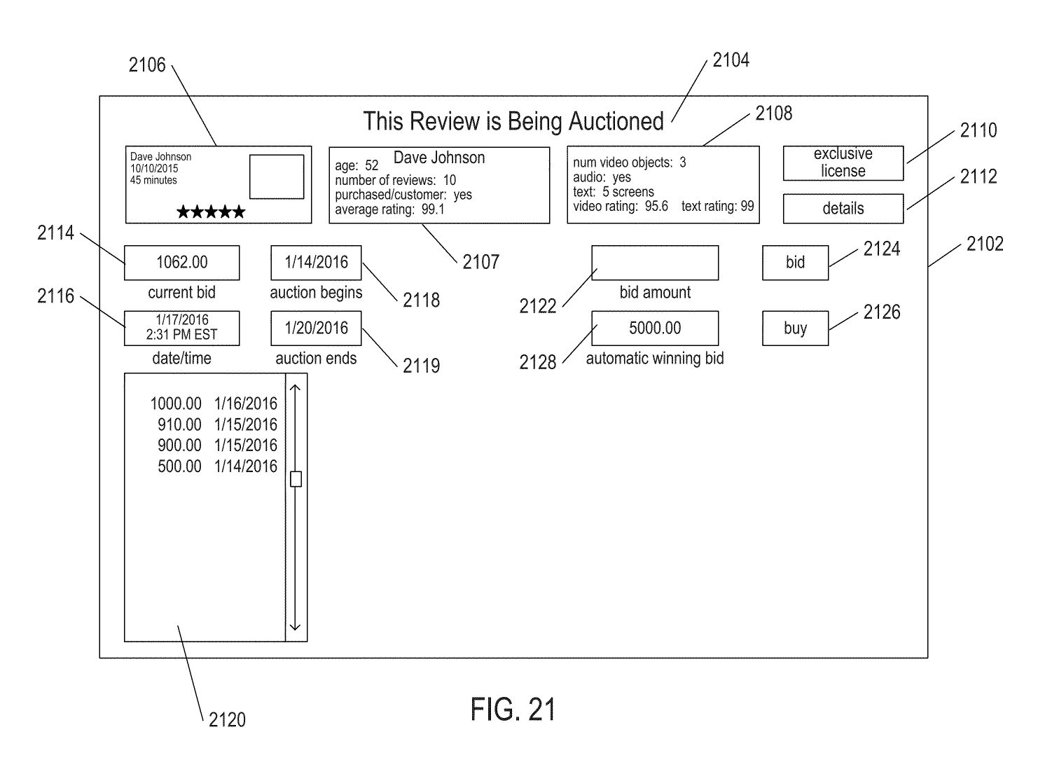

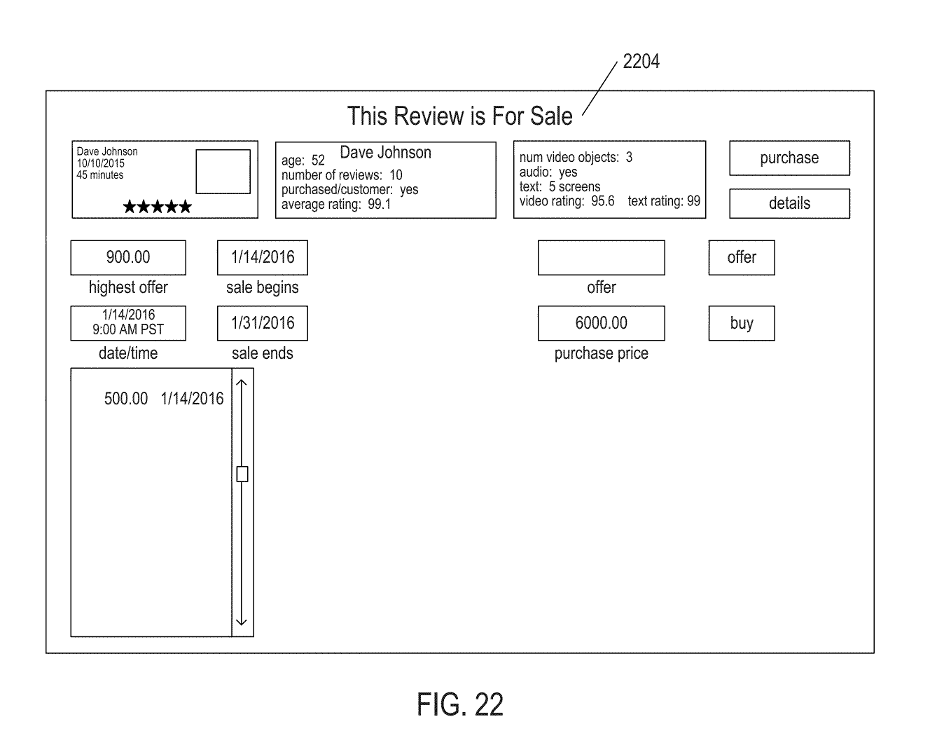

FIGS. 21-22 illustrate an auction page and a purchase page, respectively. These pages are displayed as a result of user input to input features 1928 in FIGS. 19 and 2012 in FIG. 20 of the search-results page and selections-review page, respectively. The purchase and auction pages include similar input and display features, next discussed with reference to FIG. 21. The auction page 2102 displays a banner 2104 indicating that a review selected from the search-results page or selections-review page is being auctioned. A similar banner 2204 displayed by the purchase page shown in FIG. 22 indicates that a review is available for purchase or licensing. The thumbnail and information-display features displayed for the review on the search-results page or selections-review page are again displayed 2106-2108 on the auction page. In addition, an information-display feature 2110 indicates that the review selected from the search-results page or selections-review page is available for exclusive license. Additional details are available to a user through input to a details feature 2112. The current highest bid for the review is indicated in the current-bid feature 2114. The date and time of this bid is shown in the date/time feature 2116. Indications of the beginning and ending dates of the auction of the review are shown in display features 2118-2119. Display feature 2120 provides a full list of the bids, to date. Should a user wish to bid on the review, the user can enter a bid amount in the bid-amount feature 2122 and input a mouse click to the bid feature 2124. Alternatively, a user may wish to purchase the review by input to the buy feature 2126 for an amount displayed in the automatic-winning-bid feature 2128.

The user-interface pages discussed above with reference to FIGS. 18-22 represent a small selection of many possible user-interface pages of many different possible implementations of a review-distribution-system user interface. A review-distribution system may provide more complex user-interface features to allow users to bid on groups of multi-media reviews, to download information about multi-media reviews for automated processing and bidding, and many additional types of features to facilitate sale and distribution of multi-media reviews. For example, multi-media reviews may be automatically streamed to review consumers on a subscription basis or volume-purchase or volume-licensing basis.

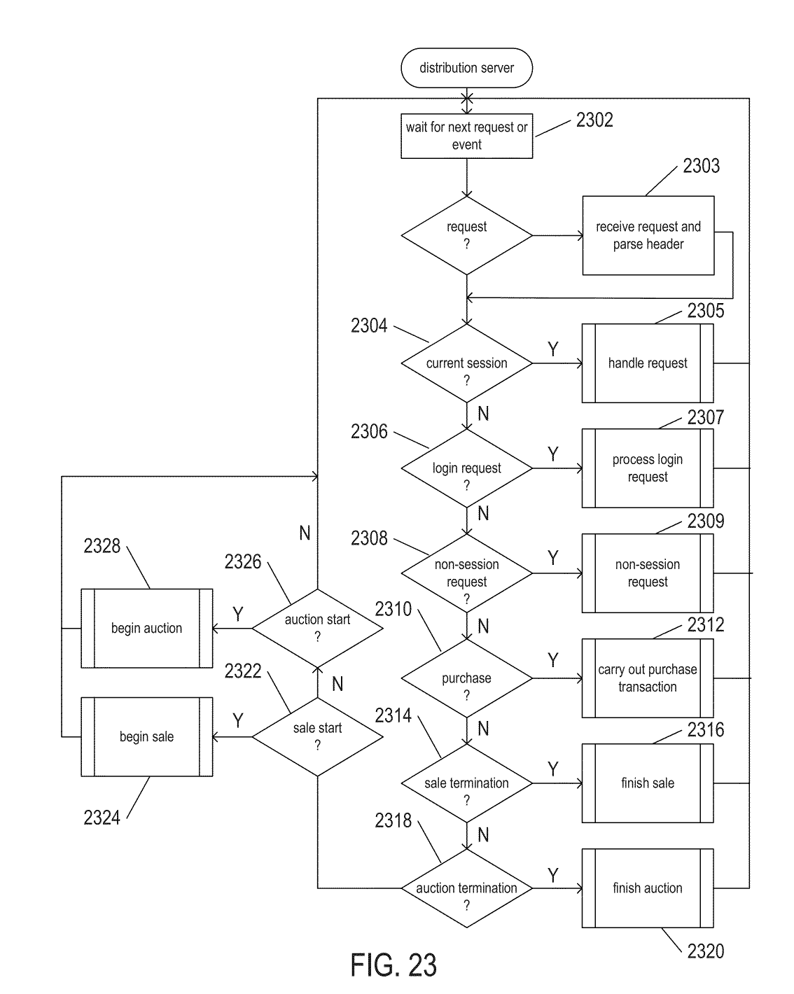

FIG. 23 is a control-flow diagram for a general implementation of the review-distribution system. This control-flow diagram is similar to FIG. 9B, discussed above, that illustrates a general implementation of the review-aggregation system. Steps 2302-2309 in FIG. 23 are similar to steps 930-942 of FIG. 9B. These steps carry out processing of requests received from remote clients. In step 2310, the review-distribution system determines whether or not a purchase event has occurred. A purchase event may be raised, by the review-distribution system, in the event that a client purchases a multi-media review from the auction page or purchase page discussed above with reference to FIGS. 21 and 22, respectively. When a purchase event occurs, a purchase transaction is carried out by the review-distribution server in step 2312. The purchase transaction may involve processing a credit-card payment, other submitted financial instrument, or other type of funds transfer and may involve third-party financial institutions and transactions. Otherwise, when a sale-termination event occurs, as determined in step 2314, then the sale termination is handled in step 2316. A sale-termination event occurs when the current time first exceeds the finish time for a particular sale. When an offer has been received for a multi-media review greater than or equal to a threshold acceptance level, then a purchase transaction is carried out in step 2316. Otherwise, the reviewer who submitted the review may be notified by the review-distribution system, by email or other method, and provided an option to resubmit the review for sale. In similar fashion, when an auction-termination event is determined, in step 2318, then the auction is completed in step 2320. When a sale-start event occurs, as determined in step 2322, an entry is added to a sales table in step 2324, and other actions are taken to ensure that the multi-media review that is being offered for sale is provided in search-results lists and otherwise made available to potential purchasers. Similarly, when an auction-start event occurs, as determined in step 2326, then entry is made into an auction table, in step 2328, and other actions are taken to ensure that the multi-media review is provided in search results and otherwise made available to potential bidders. Sale-start and auction-start events are raised by the review-distribution system when the current time first exceeds the start time associated with a multi-media review. The control-flow diagram for the inner loop of the client-side application, shown in FIG. 9A, also describes a general implementation for client applications furnished to users of the review-distribution system. Purchase-transaction completion involves transfer of the purchased multi-media object to the purchasing entity either in a stepwise fashion, using a multi-media-review-package data structure, or as a compressed media file.

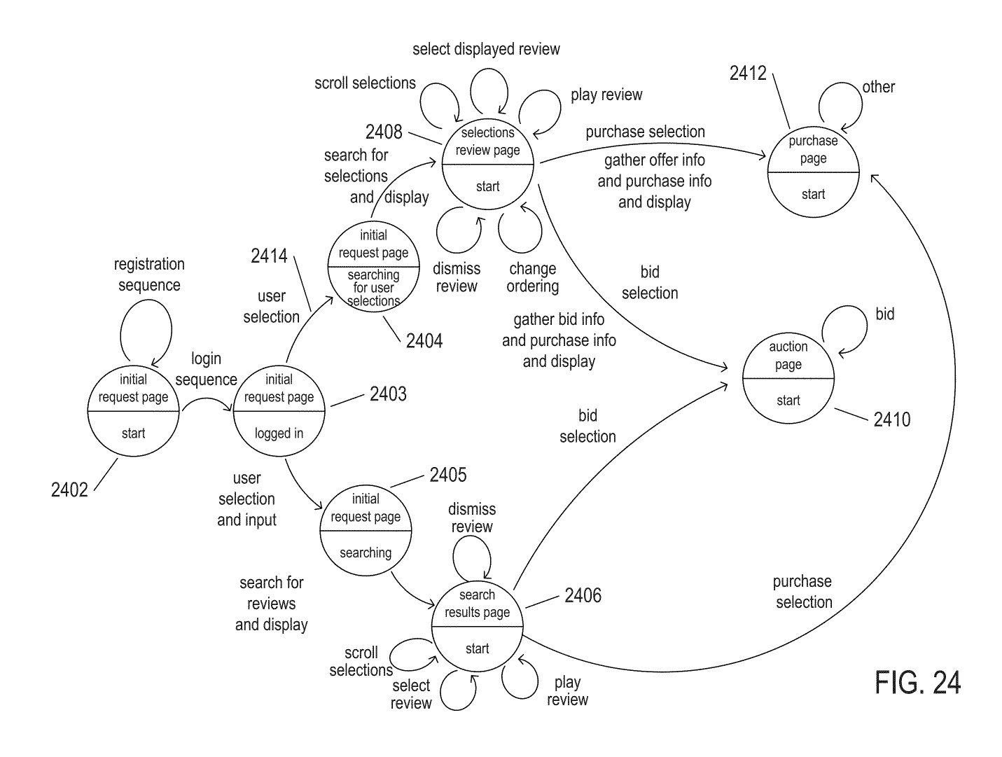

FIG. 24 provides a portion of a state-transition diagram, similar to the state-transition diagrams shown in FIGS. 10A-B, for interaction between clients of the review-distribution system and the review-distribution system. The same illustration conventions are employed in FIG. 24 as are employed in FIGS. 10A-B. States 2402 through 2405 involve the initial request page, discussed above with reference to FIG. 18. State 2406 involves the search-results page discussed above with reference to FIG. 19 and state 2408 involves the selections review page discussed above with reference to FIG. 20. State 2410 involves the auction page discussed above with reference to FIG. 21 and state 2412 involves the purchase page, discussed above with reference to FIG. 22. The state transitions, such as state transition 2414, generally involve user input to displayed user-interface pages and review-distribution-system actions needed to gather information for updating the user-interface page or displaying a next user-interface page.

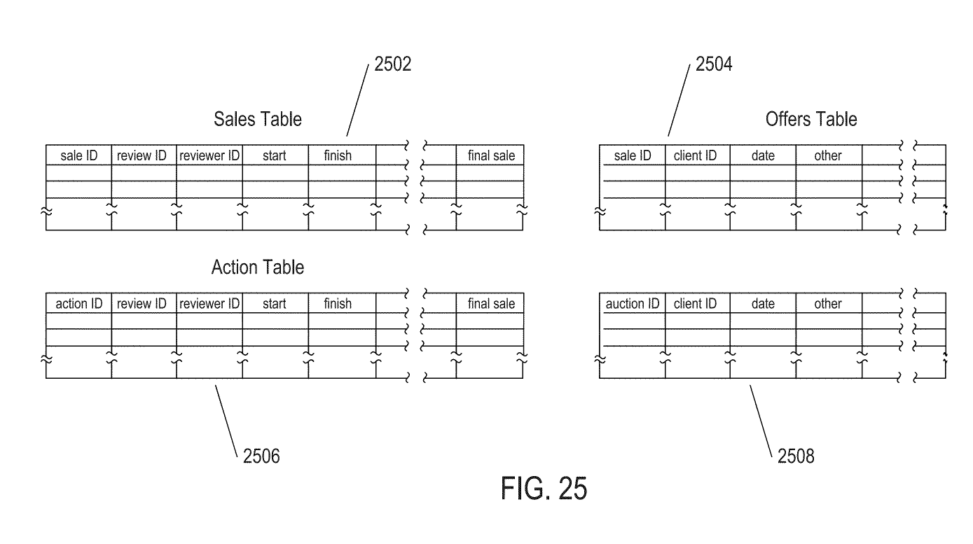

FIG. 25 illustrates additional relational database tables employed by the review-distribution system, along with tables identical or similar to the relational-database tables discussed above with reference to FIGS. 11A-B, to store information related to sales of multi-media reviews and auctions of multi-media reviews. The sales table 2502 includes entries for each multi-media review currently offered for sale. Received offers are stored in the offers table 2504. Similarly, the auction table 2506 includes entries that describe current auctions of multi-media reviews and the bids table 2508 stores bids associated with each auction.

In addition to the user-interface-based distribution of multi-media reviews discussed above with reference to FIGS. 18-25, a review-distribution system may provide many additional types of interfaces and channels for multi-media-review distribution. Multi-media reviews may be transferred, in batches, to search engines and social-networking organizations on a subscription basis or batch-purchase basis. Multi-media reviews may also be sold or licensed to third-party multi-media-distribution organizations. Batch-mode or automated streaming modes may use stored search criteria for selecting particular types of reviews for subscribers and volume purchasers.

Although the present invention has been described in terms of particular embodiments, it is not intended that the invention be limited to these embodiments. Modifications within the spirit of the invention will be apparent to those skilled in the art. For example, any of many different possible implementations can be obtained by varying one or more of many different implementation and design parameters, including modular organization, underlying hardware platform and operating system, control structures, data structures, programming language, and other such parameters. As discussed above, many different client-side-application-provided user interfaces may be designed and implemented, and the distribution servers may support handling of many additional types of requests.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A review-distribution system comprising:
a distribution server including one or more memories, one or more processors, and processor instructions stored in one or more of the one or more memories that, when executed by one or more of the one or more processors, control the distribution server to
receive requests that include
a request for information about one or more multi-media reviews stored in one or more data-storage devices by the review-distribution,
a request to search for one or more multi-media reviews stored in one or more data-storage devices by the review-distribution, and
a request to purchase or bid for one or more multi-media reviews stored in one or more data-storage devices by the review-distribution, and
respond to the received requests by
returning information requested in the request for information,
returning search results requested by the request to search, and
carrying out a purchase or bid for the one or more multi-media reviews requested by the request to purchase or bid; and
one or more processor-controlled devices controlled by client-side applications that control the one or more processor-controlled devices to transmit requests to the distribution server.

2. The review-distribution system of claim 1 wherein the review-distribution system includes multiple distribution servers provided by one or more cloud-computing facilities or by one or more private data centers.

3. The review-distribution system of claim 1 wherein the distribution server transmits a multi-media review to one or more of the one or more processor-controlled devices as a multi-media-review-package data structure that includes meta-data fields and descriptions of each media object included in the review.

4. The review-distribution system of claim 3 wherein the description of each media object includes information that the one or more of the one or more processor-controlled devices extracts and uses to download the media object or stream the media object to the one or more of the one or more processor-controlled devices.

5. The review-distribution system of claim 3 wherein the description of each media object included in the review is generated using semantic analysis of a text portion of the media object.

6. The review-distribution system of claim 3 wherein the description of each media object included in the review is generated by applying speech recognition to an audio portion of the media object.

7. The review-distribution system of claim 1 wherein information requested by the one or more processor-controlled devices and returned by the distribution server includes one or more of:
a multi-media-review-package data structure that includes meta-data fields and descriptions of each media object included in the review;
one or more ratings associated with one or more multi-media reviews;
the names of reviewers associated with one or more multi-media reviews;
the number of multi-media reviews submitted by a reviewer to the review-distribution system;
an average rating for multi-media reviews submitted by a reviewer to the review-distribution system;
a length of a multi-media review; and
a number of a type of media object included in the multi-media review.

8. The review-distribution system of claim 1 wherein the client-side application displays a web-page-based user interface to a user accessing the review-distribution system through one of the one or more processor-controlled devices.

9. The review-distribution system of claim 8 wherein the web-page-based user interface includes:
an initial request page that allows the user to request
login to the review-distribution system,
display of previously saved multi-media reviews, and
search for particular multi-media reviews based on input parameters and criteria.

10. The review-distribution system of claim 8 wherein the web-page-based user interface includes:
a search-results page that allows a user to
view a list of one or more descriptions of multi-media reviews retrieved by the review-distribution system from one or more data-storage devices in response to a search request,
play a multi-media review selected from the list of one or more descriptions of multi-media reviews, and
purchase or bid for a multi-media review selected from the list of one or more descriptions of multi-media reviews.

11. The review-distribution system of claim 8 wherein the web-page-based user interface includes:
a selections-review page that allows a user to
view a list of one or more descriptions of multi-media reviews retrieved by the review-distribution system from one or more data-storage devices in response to a request to view previously selected multi-media reviews,
play a multi-media review selected from the list of one or more descriptions of multi-media reviews, and
purchase or bid for a multi-media review selected from the list of one or more descriptions of multi-media reviews.

12. The review-distribution system of claim 1 wherein the review-distribution system streams or transmits batches of multi-media reviews to a processor-controlled device of one or more of:
a social-networking organization;
a search-engine organization; and
a volume purchaser or licensee of multi-media reviews from the review-distribution system.

13. The review-distribution system of claim 12 wherein the wherein the review-distribution system streams or transmits batches of multi-media reviews to a processor-controlled device in response to a request from a retailer of a product/service described in the multi-media reviews.

14. The review-distribution system of claim 1 wherein the request to search comprises one or more components selected from the group consisting of reviewer product/service category, product/service price, time when review was created, review's sentiment, and review's content.
